(19) United States
(12) Patent Application Publication
(10) Pub. No.: US 2004/0039637 A1
(43) Pub. Date: Feb. 26, 2004

(54) Computer network-implemented affinity program

(76) Inventors: Philip Kopf, Marietta, GA (US); Darrell Tadley, Phoenix, AZ (US)

Correspondence Address: GARDNER GROFF, P.C., PAPER MILL VILLAGE, BUILDING 23, 600 VILLAGE TRACE, SUITE 300, MARIETTA, GA, 30067, US

(21) Appl. No.: 10/630,474

(22) Filed: Jul. 30, 2003

Related U.S. Application Data
(60) Provisional application No. 60/399,992, filed on Jul. 30, 2002.

(51) Int. Cl. G06F 17/60

(52) U.S. Cl. 705/14

(57) ABSTRACT

A computer network-based affinity program provides for participants to identify spending with merchants, who then provide a benefit to a non-profit organization or other beneficiary when the participant later conducts actual spending transactions with the merchant. The program includes benefit determination methods that reconcile the actual spending with the identified spending. The benefit determination methods create “lift” for the merchant, which encourages merchant participation in the program. In addition, the benefit determination methods permit the merchants to measure and track the value of participating in the program, and the program further includes features that permit the merchants use this feedback to created tailored special promotions. In order to encourage participants to accurately estimate their identified spending, the benefit determination methods include accurate identified spending reward schemes.

### FIELD OF THE INVENTION

The present invention relates generally to affinity programs that encourage consumers to spend their money with program-member merchants by providing merchant-paid rebates to consumer-selected non-profit organizations or other beneficiaries and, more particularly, to a computer network-based system implementing such affinity programs.

### BACKGROUND OF THE INVENTION

Scrip companies are businesses that provide affinity programs using scrip for raising funds for nonprofit organizations (NPOs). “Scrip” is an instrument such as a gift certificate or gift card that is redeemable by a customer at a merchant, and that has a face value that is recognized by the customer and the merchant. A customer that is a supporter of an NPO buys gift certificates or cards at their face value. The customer/NPO supporter purchases them from the NPO or the scrip company, which negotiates better terms with the merchant based on the bargaining power of the group of customers/NPO supporters. The scrip company or NPO negotiates and purchases the gift certificates or cards at a cost that is less than the face value. When the scrip company or NPO sells the gift certificates or cards to the customers/NPO supporters at their face value, the difference between the face value and negotiated purchase price is split between the scrip company and the NPO. This helps NPOs raise funds from their supporter base without asking the supporters for any more money than what they are currently spending in the marketplace.

In addition to benefiting the NPOs, these scrip programs benefit the merchants by providing the opportunity to encourage loyalty and consistent spending from a passionate customer base. Furthermore, the merchants benefit from the “lift” provided by these programs. Lift is created for a merchant when a consumer uses a gift certificate or gift card and spends more than the face value on the certificate or card. For example, say a merchant sold a $100 certificate for $90 to a scrip company, which sold it to an NPO, which sold it to a supporter at the $100 face value. Say the NPO supporter went to the merchant and spent $125 instead of exactly the $100 face value. The additional $25 over the face value was made up of cash that was not discounted. This undiscounted $25 amount was received because of the 10% discount on the $100 amount, so this undiscounted $25 is known as the “lift” the merchant received from offering the discount. In other words, instead of the certificate costing the merchant a 10% reduction in value, it only cost an 8% reduction ($10/$125). This effective reduction of the discount percentage provided by the merchant is another way of stating the “lift.”

Although these scrip programs benefit the NPOs and the merchants, they nevertheless have a number of drawbacks. One problem is that the scrip is issued as paper certificates or gift cards, so the issuance and redemption process is very cumbersome. The physical transfer of a paper certificate or gift card requires a consumer to utilize a system of two-trip shopping to participate. First to order and pick up the actual certificates or gift cards, and second to purchase merchandise from the retailer.

In addition, the NPO must have frequent personal contact with its membership in order to facilitate scrip ordering and pick up. This limits the type and size of organization that can participate. Larger and wider-spread national organizations cannot participate due to the distribution process required under such a “paper system.”

Furthermore, when using these paper-based scrip systems, merchants cannot match redeemed scrip with intended purchases, so they can not track results to measure the success and value of participating in the scrip system. And because of the lack of this information, they cannot accurately develop store-specific marketing campaigns.

Known attempts to overcome these problems include scrip programs that capture customers' spending only after they spend their money. A benefactor rewards an NPO or other beneficiary with a benefit if a certain credit card, affinity card, or loyalty card is utilized at a specific merchant. The benefit is determined by tracking specific account or card numbers and either buying transaction data from a third party or receiving it from the merchant directly. Then the benefit is collected from the benefactor for the beneficiary. However, these programs do not provide the spending benefits, such as “lift”, provided by the paper scrip programs currently available. And they do not provide a means of measuring and tracking store traffic generated by specific marketing campaigns.

Accordingly, what is needed but not found in the prior art is an affinity program that is easier for the consumers, the merchants, and the NPOs to use. In addition, there is a need for an affinity program that permits merchants to track and measure consumer spending so that the merchants can create tailored marketing programs. Furthermore, there is a need for an affinity program that generates lift for the merchants to encourage them to participate in the program. It is to the provision of such an affinity program that the present invention is primarily directed.

### SUMMARY OF THE INVENTION

The present invention overcomes the above-described deficiencies of the prior affinity scrip programs by providing a computer network-based affinity program. Generally described, the present program provides for identifying pre-purchased, pre-funded, or pre-intended merchant spending, reconciling it against later actual spending with participating merchants, and providing a benefit to a beneficiary based upon the participant's previously identified spending. The program is implemented using a computer network, such as the Internet, that may include personal computers, laptop computers, personal digital assistants, web phones, server computers, Internet connectivity, storage backup devices, existing point-of-sale devices and processes, and transaction networks.

In an exemplary embodiment of the invention, the program generates a reconciliation report of the transactions by the participant, takes the cumulative account, segments the original identified spending and matches them with the actual spending by the participant using the program card, determines the earned benefit, generates reports for the merchants and beneficiaries, and invoices the merchants for the benefit due. In addition, the program provides for receiving the benefits and disbursing the benefits to the beneficiary.

The benefit determination method determines the earned rebate benefit payable by the participating merchant. In addition, the benefit determination method includes one or more accurate identified spending plans that adjust the benefit to encourage the participants to accurately estimate their identified spending amounts. For example, the accurate identified spending plans may provide a cap on the actual spending amount, the cap being the identified spending amount. This discourages underestimating the identified spending amounts. To discourage inflating the identified spending amount, accurate identified spending Plan “A” requires advance transfer of funds to cover, or at least to substantially cover, the amount of the identified spending. And accurate identified spending Plan “B” reduces the benefit by a fractional multiplier that is proportional to the participant's actual under-spent amount. It will be understood that other benefit determination methods and accurate identified spending plans are contemplated and within the scope of the present invention.

Accordingly, the present invention provides a number of advantages over known affinity scrip programs. Because the program of the present invention is implemented over a computer network, participants can access their funds much faster than the current paper processes. Currently a nonprofit supporter orders scrip gift certificates or gift cards from their nonprofit for a specific merchant. By the time the order is processed and the gift cards or certificates are received by the supporter, it may be several days to a week. On the other hand, the program of the present invention provides the participant access to funds either immediately (when funds are not required to be transferred), or when actual funds transfer is required within a day or two, depending on what time of the day the funding occurred. In addition, the NPOs no longer need to have personal contact with their supporter base to deliver the gift certificates or gift cards. Furthermore, the program of the present invention reduces the quantity of paper certificates and gift cards a person needs to carry. The program effectively takes multiple merchant's paper certificates and gift cards and puts them on one card.

In addition, the program captures identified spending with a merchant up front, captures actual spending at the merchant at a later date, matches or reconciles the two together, and determines the benefit payable by the merchant, thereby tracking and measuring the commercial advantage to the merchant of participating in the program. And then, using this information, the merchant can create dynamic marketing opportunities targeting the participants to generate more sales. In particular, the present program includes a welcome promotion feature and a special promotion feature that the merchant can use to dynamically control the benefits it pays to the beneficiary. For example, say a restaurant is slow on Tuesdays. The restaurant can use the special promotion feature of the program to set up a Tuesday special, for example, providing double the normal benefit to the beneficiary if participants buy a meal at the restaurant on a Tuesday.

Another advantage of the program is the automatic funding and/or standing order functions, which a participant can use to make identifying spending easier. As an example, say a person currently purchases MACY'S paper scrip gift certificates from her NPO, but the NPO only takes orders on Monday. So the person tries to make a habit of always buying $50 of MACY'S gift certificates on Monday. But if she forgets to buy her certificates one week, MACY'S may lose her spending for that week. With the present program, a participant can set up a standing order to automatically identify spending of $50 with MACY'S every Monday, and to automatically fund her card, if necessary, with the $50 amount allocated to MACY'S purse. Once this is set up in the program, the user no longer has to remember to identify spending at MACY'S every Monday; the program will automatically do it for her.

In addition, current electronic card-based programs require the merchant to pay a discount on 100% of the participant's purchase. For example, if a merchant agrees to provide a 10% discount or rebate under current electronic card-based programs, the merchant must provide a rebate or benefit on the entire purchase amount of the transaction. This type of electronic card-based program does not allow the merchant to receive the benefit of “lift” as they currently do under paper based gift certificate or gift card programs. But with the present program, the merchant pays a benefit that is determined based on a settled transaction amount, which is based on the customer's advance identified spending and his later actual spending with the merchant. Under the benefit determination methods of the present invention, the earned rebate benefit percentage is less than the negotiated rebate when the participant's intended spending is lower or higher than his actual spending with the merchant. This discourages inflating or underestimating identified spending. Also, by using the present program, the merchant receives “lift” (incremental spending above the amount discounted to the participant) throughout the spending cycle. Merchants do not receive this benefit under the currently available electronic card-based scrip programs.

Moreover, the present program uses the existing sales transaction processing infrastructure to transact purchases. That is, the program can be used with conventional point-of-sale terminals used to swipe credit and debit cards without the need to modify or reconfigure these terminals. This makes the program easier to implement and more attractive to merchants because no modifications are required in the current point-of-sale equipment.

The specific techniques and structures employed by the invention to improve over the drawbacks of the prior programs and accomplish the advantages described will become apparent from the following detailed description of the embodiments of the invention and the appended drawings and claims.

### BRIEF DESCRIPTION OF THE DRAWINGS

FIG. 1 is a block diagram of the major components of a computer network for implemented an affinity program according to an exemplary embodiment of the present invention.

FIG. 2 is a flow diagram (also labeled Flowchart 1) showing the “Accessing the Website” process of the computer network-implemented affinity program of FIG. 1.

FIG. 3 is a flow diagram (also labeled Flowchart 2) showing the “Participant Application” process introduced in FIG. 2.

FIG. 4 is a flow diagram (also labeled Flowchart 3) showing the “Merchant Application” process introduced in FIG. 2.

FIG. 5 is a flow diagram (also labeled Flowchart 4) showing the “Beneficiary Application” process introduced in FIG. 2.

FIG. 6 is a flow diagram (also labeled Flowchart 5) showing the “User Identification” process introduced in FIG. 2.

FIG. 7 is a flow diagram (also labeled Flowchart 5A) showing the “Participant Options” process introduced in FIG. 5.

FIG. 8 is a flow diagram (also labeled Flowchart 5A1) showing the “Quick Funding” process introduced in FIG. 7.

FIG. 9 is a flow diagram (also labeled Flowchart 5A2) showing the “Automatic Funding/Standing Order” process introduced in FIG. 7.

FIG. 10 is a flow diagram (also labeled Flowchart 5A3) showing the “Find Merchants” process introduced in FIG. 7.

FIG. 11 is a flow diagram (also labeled Flowchart 5A3A) showing the “Beneficiary Checkout” process introduced in FIG. 10.

FIG. 12 is a flow diagram (also labeled Flowchart 5A3A1) showing the “Participant Account Funding” process introduced in FIG. 11.

FIG. 13 is a flow diagram (also labeled Flowchart 5A4) showing the “Participant Account Balance Adjustment” process introduced in FIG. 7.

FIG. 14 is a flow diagram (also labeled Flowchart 5A4A) showing the “Participant Checkout” process introduced in FIG. 13.

FIG. 15 is a flow diagram (also labeled Flowchart 5B) showing the “Merchant Options” process introduced in FIG. 6.

FIG. 16 is a flow diagram (also labeled Flowchart 5B1) showing the “Merchant Base Discount/Welcome Rebate/Special Discount” processes introduced in FIG. 15.

FIG. 17 is a flow diagram (also labeled Flowchart 5C) showing the “Beneficiaries Options” process introduced in FIG. 5.

FIG. 18 is a flow diagram (also labeled Flowchart 5C1) showing the “Creating Beneficiary Sub-Groups” process introduced in FIG. 17.

FIG. 19 is a flow diagram (also labeled Flowchart 6) showing the beginning of the “Transaction Reconciliation” process introduced in FIG. 2.

FIG. 20 is a flow diagram (also labeled Flowchart 6A) showing the “Debit or Credit Determination” process for Plan “A” introduced in FIG. 19.

FIG. 21 is a flow diagram (also labeled Flowchart 6A1) showing the “Welcome Rebate Reconciliation” process for Plan “A” introduced in FIG. 20.

FIG. 22 is a flow diagram (also labeled Flowchart 6A1A) showing the “Special Discount Reconciliation” process for Plan “A” introduced in FIG. 21.

FIG. 23 is a flow diagram (also labeled Flowchart 6A1A1) showing the “Base Discount Reconciliation” process for Plan “A” introduced in FIG. 22.

FIG. 24 is a flow diagram (also labeled Flowchart 6A1A1A) showing the “Identified Spending Account Adjustment” process for Plan “A” introduced in FIG. 23.

FIG. 25 is a flow diagram (also labeled Flowchart 6A2) showing the beginning of the “Identified Spending Reconciliation” process for Plan “A” introduced in FIG. 20.

FIG. 26 is a flow diagram (also labeled Flowchart 6A2A) showing the rest of the “Identified Spending Reconciliation” process for Plan “A” introduced in FIG. 25.

FIG. 27 is a flow diagram (also labeled Flowchart 6B) showing the “Debit or Credit Determination” process for Plan “B” introduced in FIG. 19.

FIG. 28 is a flow diagram (also labeled Flowchart 6B1) showing the “Qualifying Transaction Determination” process for Plan “B” introduced in FIG. 27.

FIG. 29 is a flow diagram (also labeled Flowchart 6B1A) showing the “Welcome Rebate Reconciliation” process for Plan “B” introduced in FIG. 28.

FIG. 30 is a flow diagram (also labeled Flowchart 6B1A1) showing the “Special Rebate Reconciliation” process for Plan “B” introduced in FIG. 29.

FIG. 31 is a flow diagram (also labeled Flowchart 6B1A1A) showing the “Base Discount Reconciliation” process for Plan “B” introduced in FIG. 30.

FIG. 32 is a flow diagram (also labeled Flowchart 6B1A1A1) showing the “Transaction File End” process for Plan “B” introduced in FIG. 31.

FIG. 33 is a flow diagram (also labeled Flowchart 6B2) showing the “Identified Spending Reconciliation” process for Plan “B” introduced in FIG. 27.

### DETAILED DESCRIPTION OF THE EXEMPLARY EMBODIMENTS

A computer network-based affinity program according to an exemplary embodiment of the present invention will now be described. The program provides for participants to identify pre-purchased, pre-funded, or pre-intended spending with merchants, who then provide a benefit to a non-profit organization when the participant purchases goods or services with the merchant.

For purposes of illustration, the program is described herein as implemented in a website for use by merchants, participants, and non-profit organizations, with the participants typically being consumers. It will be understood, however, that benefactors other than merchants, beneficiaries other than non-profit organizations, and participants other than consumers can participate in the program. In addition, in some circumstances it may be desirable to implement the program on a computer network in another form than a website.

In this description of the exemplary embodiment, including the appended drawings and claims, a number of unique terms are used. These terms are intended to be broadly construed, and not unnecessarily limited, in light of the following definitions:

User—a person who accesses the program website, whether a participant, a merchant, an NPO, a program administrator, or a non-participant.

Program Administrator—a person, organization, or company that administers the program by overseeing the participation of the participating merchants, the participants, and the beneficiaries.

Beneficiary—an individual, organization, or company that is designated by a participant to receive a benefit from a benefactor, typically the beneficiary is a non-profit organization.

Non-profit organization (NPO)—an organization that operates for the benefit of others and does not retain earnings, for example, THE HUMANE SOCIETY, schools, churches, youth organizations, and civic organizations.

Sub-Group—a designated internal recipient of the benefit, or a portion of it, that the beneficiary receives. For example, a beneficiary that is a school may set up sub-groups such as band, booster club, etc.

Benefit—cash, discounts, rewards, credits, redeemable points, services, or other things of value that are provided to the beneficiary.

Participant—an individual or company that participates in the program, typically the participant is a consumer.

Cardholder—one who is issued a card and participates in the program, i.e., a participant.

NPO Supporter—one who supports or is a member of a participating non-profit organization or other beneficiary who is in the program, i.e., a participant.

Benefactor—an individual or organization that provides a benefit to a beneficiary designated by a participant, typically the benefactor is a merchant.

Merchant—a buyer and/or seller of goods and/or services for profit, for example, a retail outlet such as a department store or a grocery store, or a service provider such as a restaurant or salon.

Participating Merchant—a merchant who takes part in the program.

Nonparticipating Merchant—a merchant who does not take part in the program.

Network of Merchants—a group of merchants who participate in the program.

Out-of-Network—purchases from nonparticipating merchants.

In-Network—purchases from participating merchants.

Purse—a “virtual” account where a participant can identify spending.

Merchant Purse—a purse associated with a specific participating merchant where a participant can identify spending with that merchant.

General Purse—a purse associated with no specific merchant where a participant can identify spending with no specific participating merchant in mind, so that the participant can later conduct an account balance adjustment to transfer funds from his general purse to a specific merchant's purse, or vice versa, as desired.

Pre-purchased Spending—an advance payment of a value, such as a dollar amount, that a participant pays for a product or service from a specific merchant.

Pre-funded Spending—an advance payment of a value, such as a dollar amount, that a participant places on reserve or on hold for a product or service from a specific merchant.

Pre-intended Spending—an identification of an intended future payment, such as a dollar amount, that a participant makes for a product or service from a specific merchant. In other words, a budget for spending at specific merchants participating in the program.

Identified Spending (IS)—pre-purchased, pre-funded, or pre-intended spending that is identified before the actual spending.

Actual Spending (AS)—the amount a participant actually spends on purchases from a participating merchant using a program card.

Effective Actual Spending (EAS)—the amount a participant actually spends on purchases from a participating merchant using a program card, or the identified spending amount, whichever is less. In other words, the effective actual spending is capped at the identified spending amount.

Funding Method—a method a participant uses to transfer funds into its account if advance funds transfer is required for participation in the program. These methods include but are not be limited to transfers from checking accounts, savings accounts, or credit card accounts.

Shopping Cart—a “virtual” shopping basket on the website where a participant holds identify spending selections while continuing to shop with other merchants until checkout.

Card—an item, which is not necessarily a physical “card,” that is used by a participant for transacting purchases with merchants so that the participant's actual spending can be input into the program for determining benefits. For example, the card may be in the form of a credit card, debit card, stored-value card, affinity card, smart card, check, or other card or other device such as a contactless payment product that is tied to a card that is issued through the program or issued through a bank or other card issuer but registered with the program.

Acquiring Bank—a bank that maintains financial responsibility for the merchant's acceptance of a card.

Issuing Bank—a bank that maintains financial responsibility for the participant's card account, if one is required. The issuing bank may also provide for the creation and mailing of cards to the participants.

Settlement Account—an account that sales transactions are paid from.

Processing Network—a network that sales transactions are processed through. Examples of networks include MASTERCARD, VISA, STAR, and TELECHECK.

Point-of-Sale (POS) Network—a network of organizations and/or companies that a merchant uses to process sales transactions made through the merchant's POS terminal.

Quick Funding—a feature of the program that identifies a participant's historical spending over a given period of time and presents a menu of the previously used participating merchants to the participant for quick access to identify pre-purchased, pre-funded, or pre-intended spending.

Standing Order/Automatic Funding—an automated process that permits participants to identify pre-purchased, pre-funded, or pre-intended spending on a regular, repeating basis such as weekly, or monthly.

Dynamic Marketing—tools such as email marketing and electronic marketing programs targeted to specific cardholders based on specific criteria.

Lift—undiscounted incremental spending by a participant above the amount discounted by the merchant, also characterized as the effective reduction in the discount percentage provided by the merchant.

Earned Rebate (ER)—the total benefit amount payable by a participating merchant based on a participant's identified spending and his actual spending with the merchant using his program card. The ER is the sum of (i) the administrative rebate and (ii) and the beneficiary rebate. In addition, the ER is the product of (i) the earned rebate percentage and (ii) the effective actual spending.

Earned Rebate Percentage (ERP)—the percentage used to determine the earned rebate generated by a participant's actual spending with a participating merchant. In addition, the ERP is the sum of (i) the administrative rebate percentage and (ii) the beneficiary rebate percentage.

Administrative Rebate (AR)—the portion of the earned rebate that is retained by the company that administers the program. The AR is the product of (i) the administrative rebate percentage and (ii) the effective actual spending.

Administrative Rebate Percentage (ARP)—the percentage used to determine the administrative rebate generated by a participant's actual spending with a participating merchant using the card.

Beneficiary Rebate (BR)—the portion of the earned rebate that the beneficiary ultimately receives under the program. The beneficiary rebate is the product of (i) the beneficiary rebate percentage and (ii) the effective actual spending.

Beneficiary Rebate Percentage (BRP)—the percentage used to determine a beneficiary rebate generated by a participant's actual spending with a participating merchant.

Negotiated Rebate Percentage (NRP)—the percentage that a participating merchant agrees will be used as the base discount for determining the earned rebate. When the participant's actual spending is the same as his intended spending, then the earned rebate percentage is the NRP. Typically the participant's actual spending is not exactly the same as his intended spending, so the earned rebate percentage is usually less than the NRP. Thus, the NRP is the maximum possible earned rebate percentage.

Rebate—an earned rebate, welcome promotion rebate, special promotion rebate, or other benefit provided by a participating merchant under the program.

Welcome Promotion—a promotion in which a participating merchant agrees to pay an amount to a participant, a NPO, or another beneficiary when the participant makes a first purchase from the merchant and fulfills the merchant's predefined rules for the welcome promotion, terms, and conditions, including, without limitation, those concerning identified spending, actual spending, and use of the card.

Welcome Promotion Rebate (WPR)—the amount payable by a participating merchant based on a participant's actual spending with the merchant using the card under a welcome promotion. The WPR is the product of (i) the welcome promotion percentage and (ii) the effective actual spending.

Welcome Promotion Percentage (WPP)—the percentage that a participating merchant agrees to have used to determine the welcome promotion rebate. The merchant selects the WPP in the program by accessing the website.

Special Promotion—a promotion in which a participating merchant agrees to pay an amount to a participant, a NPO, or another beneficiary based on the participant's actual spending, provided that the participant fulfills the merchant's predefined rules, terms, and conditions for the special promotion, including, without limitation, those concerning identified spending, actual spending, and use of the card.

Special Promotion Rebate (SPR)—the amount payable by a participating merchant based on a participant's actual spending with the merchant using the card under a special promotion. The SPR is the product of (i) the special promotion percentage and (ii) the effective actual spending.

Special Promotion Percentage (SPP)—the percentage that a participating merchant agrees to have used to determine the special promotion rebate. The merchant selects the SPP in the program by accessing the website.

Credit—an actual credit, earned rebate credit, or other credit to a participating merchant under the program.

Actual Credit (AC)—the amount of the participant's actual spending is credited to the participant's card by a participating merchant when the participant returns or exchanges goods or services purchased under the program.

Earned Rebate Credit (ERC)—the amount of credit due a participating merchant when the merchant has already paid the respective beneficiary rebate. The ERC is the product of (i) the actual credit and (ii) the average beneficiary rebate.

Average Beneficiary Rebate Percentage (ABRP)—the average of the beneficiary rebate percentages over a predetermined period of time. For example, the average beneficiary rebate percentage can be based on a three-month period immediately prior to the time the actual credit was issued.

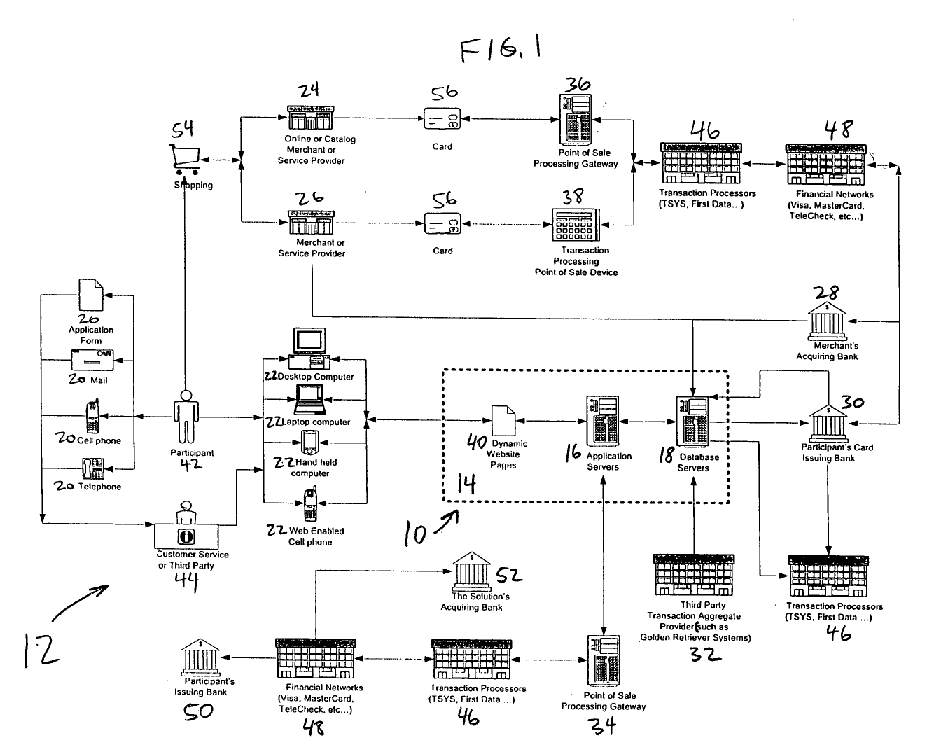

Referring now to the drawing figures, FIG. 1 shows a block diagram of the major components of a computer network-based system 12 for implementing the program 10. The system 12 includes a main computer 14, for example, a bank of application servers 16 and database servers 18. The main computer 14 communicates with participant interface devices 20 and 22, merchants 24 and 26, the merchant's acquiring bank 28, the participant's card issuing bank 30, a third party transaction aggregate provider 32, and a POS processing gateway 34. The main computer 14, participant interface devices 20 and 22, and merchant POS devices 36 and 38 can be provided by conventional devices well known in the art, with no modifications or special configuring required. The communication can be via the Internet, a Local Area Network, a Wide Area Network, or another wired or wireless network. Where the communication is via the Internet, the invention is typically embodied in a website 40 with separate controlled-access areas for participants, merchants, and non-profit organizations.

The program 10 will now be described with reference to the major components of the computer network-based system 12. When accessing the program 10, a participant 42 such as a customer has several options for communicating with the main computer 14. The participant 42 can use interface devices 22 such as a desktop computer, a laptop computer, a handheld computer, or a web-enabled cell phone to communicate his identified spending information to the main computer 14. Alternatively, the participant 42 can use interface devices 20 such as an application form, regular mail, a cell phone, or a telephone to communicate with a third party 44 such as a customer service representative. Once the customer service representative 44 has received from the participant 42 his identified spending information, the representative then communicates this information to the main computer 14 via an interface device 22 such as a desktop computer, a laptop computer, a handheld computer, or a web-enabled cell phone.

In any event, the interface devices 22 communicate with the program 10 through dynamic website pages 40 that are delivered from the application servers 16, which receive data and information from the database servers 18. Typically the website pages 40 are stored on hard drives of the application servers 16. Alternatively, the website pages 40 may be stored on another computer-readable storage device such as diskettes, CD-ROM discs, DVDs, flash memory, etc.

In order to use the program 10, the participants 42 use the interface devices 22 to access the website 40 and communicate their identified spending with specified merchants to the program 10, which stores this identified spending information on the database servers 18. The participants can select one merchant, identify spending for that merchant, and then checkout. Or they can fill up their shopping cart with identified spending at multiple merchants and then checkout for all the selected merchants' identified spending at once. In addition, the program 10 communicates to the participant 42 information about his participation in the program through the dynamic website pages 40.

If advance funds transfer is required from the participant 42, then the program 10 requests information about the intended payment method from the participant. The program 10 then communicates this transaction payment information through the POS processing gateway 34, to the transaction processors 46, to the financial networks 48, and to the participant's issuing bank 50 and the program's acquiring bank 52. Then the transaction processors 46 communicate back through the POS processing gateway 34 to the program 10 with information about the availability of funds from the participant 42. If sufficient funds are available, then the program 10 stores the available funds information in the database servers 18 and transfers the information to the participant's card-issuing bank 30, which then transfers the information to the transaction processor 46. Alternatively, the program 10 can send the available funds information directly to the transaction processor 46 instead of through the participant's card-issuing bank 30.

After the participant 42 has input his identified spending information and, if necessary, transferred the needed funds, the participant 42 then goes shopping as indicated at 54. The participant 42 can shop at online/catalog/mail order merchants 24 or at brick-and-mortar merchants 26. The participant 42 uses his program card 56 for his purchases. The card 56 may be a dedicated affinity program card, a combination affinity program card and credit or debit card, or another type of card or payment device that the participant registers with the program 10 so that the actual spending is captured by the program. For example, the participant's card 56 can be an existing credit card that the participant 42 registers with the program 10 using the website 40, the card 56 can be a new credit card that the participant requests and has issued from the program 10, the card 56 can be an affinity program card for use when making cash purchases, or the card 56 can even be a checking account. It will be understood, then, that the program card 56 is not limited to a “card” in the conventional meaning of the word.

Using the participant's card 56, the merchant 24 or 26 sends the transaction information through the POS processing gateway 36 or the transaction processing POS terminal 38. The POS devices 36 and 38 communicate with the transaction processors 46, which approve or decline the purchase and communicate the approval/decline back to the POS devices 36 and 38 and to the merchant 24 or 26. The transaction processor 46 then communicates the transaction information to the financial networks 48, to the merchant's acquiring bank 28, and to the participant's card issuing bank 30.

Information about the participant's actual spending on purchases is communicated from the merchant 24 or 26, the transaction processors 46, the merchant's acquiring bank 28, the participant's card issuing bank 30, or a third party transaction aggregate provider 32 to the program 10 and stored in the database servers 18. The program 10 then determines the earned rebate benefit for any identified spending using the card 56 that is now payable by the merchant 24 or 26, including the administrative rebate for the program administrator and the beneficiary rebate for the NPO or other beneficiary designated by the participant 42. The benefit determination method reconciles the identified pre-purchased, pre-funded, or pre-intended spending with the participant's actual spending using the card at the participating merchants.

According to the exemplary benefit determination methods described herein, after the participant designates his intended spending with specific participating merchants, the participant is allowed a predetermined time period to generate an earned rebate based on that identified spending. The predetermined time period can be, for example, one month after the date the participant designates the identified spending. In an alternative embodiment, the predetermined time period is one month starting on the same day every month period, regardless of the exact date the participant designates his identified spending, so that the benefit determination method is based on a repeating monthly cycle. In other alternative embodiments, the predetermined time period is set at another length of time, is set at different lengths of time depending on the amount of identified spending, is set by the participant, or a combination of these. In any event, once the predetermined time period expires, the benefit determination method for that identified spending is finalized and completed, the resulting earned rebate becomes payable by the merchant, and the identified spending and the actual spending by the participant at the merchant are reset to zero.

In addition, it should be noted that the benefit determination method is based on actual spending, which includes only purchases using program cards at participating merchants. So if a participant uses a payment method other than a program card to pay for a purchase from a participating merchant, including, without limitation, cash, check, credit card, debit card, or another card that is not registered as a program card, the participant's payment for the purchase is not considered actual spending. Thus, this purchase will not be included in the benefit determination method. Similarly, if a participant uses a program card to pay for a purchase from a nonparticipating merchant, the participant's payment for the purchase is not considered actual spending.

In order to encourage the participants to more thoughtfully and accurately estimate their identified spending, the benefit determination method of the program 10 includes one or more accurate identified spending reward plans. Because benefits are determined by how accurate a participant predicts their future spending with a given merchant, the participants will tend to estimate their identified spending more accurately, and the merchants will receive better information on the volume of sales they can expect, and from whom. With this better expected sales information and spending pattern information, the merchants can better customize their marketing efforts.

If multiple accurate identified spending reward plans are included in the program 10, the program can be configured to permit the participant, the program administrator, or the NPO to decide which plan the participant has his earned rebate determined by. In addition, the program can be configured to permit this decision be made once, for example, when the participant applies for the program, for each identified spending by the participant, or at another time as may be desirable.

Two exemplary benefit determination methods with different accurate identified spending reward plans, referred to as Plan “A” and Plan “B,” will now be described. Both plans are designed to encourage the participants to accurately estimate their identified spending, to pay the program administrator the same benefit regardless of how accurately the participants estimate their identified spending, and to generate “lift ” for the merchants. Additionally, in both plans the actual spending is considered to be effectively capped at the identified spending amount that the participant designated. In other words, the benefit determination method uses the effective actual spending, which is the smaller of the actual spending and the identified spending. So if the participant's actual spending is less than his identified spending, then the effective actual spending used by the benefit determination method is the actual spending amount. But if the participant's actual spending is more than his identified spending, then the effective actual spending used by the benefit determination method is the identified spending amount. In this way, the beneficiary's rebate is based on no higher amount than the identified spending, so the beneficiary's rebate is capped at the amount it would have received if the participant had only spent the identified amount, thereby discouraging the participants from underestimating their identified spending. Because the beneficiary gets no benefit for the excess spending by the participant, he will tend to more thoughtfully and accurately estimate his identified spending.

It will be understood that the accurate identified spending reward plan can be otherwise configured to discourage underestimating of identified spending. For example, the accurate identified spending reward plan can include a fractional multiplier for excess actual spending (over the identified spending amount), with the multiplier being smaller for larger excess actual spending. The multiplier could be determined as the excess actual spending divided by the identified spending, using the same logic as is employed in Plan “B” described below.

In order to discourage participants from overestimating and inflating their identified spending amounts in an effort to always capture all of their spending, in accurate estimation reward Plan “A” the participant is required to transfer funds in advance of the actual spending. Typically, the participant transfers the funds in the amount of the identified spending at the time of designating the identified spending. The program provides for conducting the advance funds transfer, as described below.

Accordingly, under Plan “A” the benefit rebate paid to the participant's designated beneficiary is determined as follows:

BR=EAS*(NRP−ARP)

The result of all of this is that in order to get the best rebate for his beneficiary, the participant has to carefully and accurately estimate his identified spending.

For example, say a participant identifies spending at a merchant in the amount of $200. The program requires receipt of the $200 amount from the participant prior to the funds becoming available to the participant on the program card. The participant then spends $100 at the merchant. Say that the merchant's base discount is 10%. Therefore, the benefit owed by the merchant is ($100)*(10%) or $10. Since the participant had to actually transfer money in advance of making the purchase, the participant would hesitate to identify an inflated amount, say $5000 per merchant, since that would require him to actually transfer $5000 per merchant.

Under accurate estimation reward Plan “B,” the benefit rebate paid to the participant's designated beneficiary is determined using a multiplier that represents the percentage of under-spending, as follows:

BR=(EAS)*(NRP−ARP)*(EAS/IS)

Using this formula, if the participant's actual spending is less than his identified spending, then the EAS will be the same as the AS, and the value (EAS/IS) will be a fraction less than one representing the participant's percentage of under-spending. So the beneficiary rebate is reduced by the same percentage that the participant has under-spent. The result of all of this is the creation of a sliding scale that maximally rewards the beneficiary the closer the participant's actual spending is to his identified spending. In other words, in order to get the best rebate for his beneficiary, the participant has to carefully estimate his identified spending and not inflate his identified spending or he will end up effectively under-spending.

For example, say a participant identified spending at a participating merchant in the amount of $200. No actual funds transfer is required, but might occur if using a stored value card. Then the participant spends $100 at the merchant's store using his program card. Say that the merchant's base discount is 10%, the administrative rebate percentage is 4%, and the beneficiary's rebate percentage is 6%. Using the above formula for Plan “B,” the benefit owed by the merchant would be [4%+($100)*(6%)/($200)]*$100=$7.00. If the participant later spends another $75 at the merchant, then the benefit would be recalculated as [4%+($175)*(6%)/($200)]*$175=$16.19. Accordingly, the benefit continues to increase to the maximum benefit the merchant agreed to, the 10% figure, as the participant's actual spending approaches what they identified prior to the actual purchase.

In addition, the program may be configured to permit a participant to additional new identified spending for a participating merchant while he still has pending identified spending for that merchant (i.e., the predetermined time period has not expired for the previously entered identified spending). Under Plan “B” of the exemplary embodiment, when the participant enters the additional identified spending, the benefit determination for the pending identified spending is finalized and completed early, the earned rebate generated for the pending identified spending based on the actual spending to date in the uncompleted time period, and the actual spending and time period is reset to zero. This prevents a participant from identifying spending at a merchant after the actual spending has occurred.

The benefit determination method of Plan “B” may be better understood with reference to the following additional examples. In these examples, the following assumptions are made:

NRP=10.0%

ARP=4.0%

### EXAMPLE #1

A participant does not identify spending in a participating merchant's establishment. The participant then uses his program card to purchase goods or services at the merchant's establishment for $100. The AS is $100, but because the participant did not identify spending, the IS=$0. The EAS is the smaller of the AS and the IS, so the EAS=$0. Accordingly, the BR=$0.0

| | |
|---|---|
| IS = $0.00 | ERP = 0.0% |
| AS = $100.00 | AR = $0.00 |
| EAS = $0.00 | BR = $0.00 |
| ARP = 0.0% | ER = $0.00 |
| BRP = 0.0% | Lift = $100.00 |

### EXAMPLE #2

A participant identifies $125 to be spent in the merchant's establishment. The participant uses his program card to purchase goods or services at the merchant's establishment for $100.The IS>0 and the AS<IS, therefore:

| IS = $125.00 | ERP = 4.0% + 4.8% = 8.8% |
|---|---|
| AS = $100.00 | AR = 4.0% * $100 = $4.00 |
| EAS = $100.00 | BR = 4.8% * $100 = $4.80 |
| ARP = 4.0% | ER = $4.00 + $4.80 = $8.80 |
| BRP = [($100/$125) * (10.0% − | Lift = $100 − ($8.80/10%) = $12.00 |
| 4.0%)] = 4.8% | |

### EXAMPLE #3

The participant from Example #2 identified an additional $100 to be spent with merchant before the end of the benefit determination time period. The participant had pending IS ($125) in the program, so the ER₍₁₎ ($8.80) is finalized and completed. The previous ER₍₁₎ from Example #2 is still due from the merchant. A new ER₍₂) calculation begins for the new identified spending. The participant then uses his program card to purchase goods or services from the merchant for $50. The IS>0 and the AS<IS, therefore:

| IS = $100.00 | ERP = 4.0% + 3.0% = 7.0% |
|---|---|
| AS = $50.00 | AR = 4.0% * $50 = $2.00 |
| EAS = $50.00 | BR = 3.0% * $50 = $1.50 |
| ARP = 4.0% | ER₍₂₎ = $2.00 + $1.50 = $3.50 |
| BRP = [($50/$100) * (10.0% − | Lift = $50 − ($3.50/10%) = $15.00 |
| 4.0%)] = 3.0% | |

### EXAMPLE #4

A Participant identifies $125 to be spent with the merchant. The participant uses his program card to purchase goods or services from the Merchant for $150. The IS>0 and the AS>IS, therefore:

| | |
|---|---|
| IS = $125.00 | ERP = 4.0% + 6.0% = 10.0% |
| AS = $150.00 | AR = 4.0% * $125 = $5.00 |
| EAS = $125.00 | BR = 6.0% * $125 = $7.50 |
| ARP = 4.0% | ER = $5.00 + $7.50 = $12.50 |
| BRP = 10.0% − 4.0% = 6.0% | Lift = $150 − ($12.50/10%) = $25.00 |

### EXAMPLE #5

A participant returns $100 worth of merchandise that he purchased from a participating merchant using his program card. The merchant credits the participant's program card the $100 amount of the purchase. The AC=$100, therefore:

| | |
|---|---|
| AC = $100.00 | ERC = 3.75% * $100 = $3.75 |
| ABRP = 3.75% | |

(assumed for this calculation)

### EXAMPLE #6

A merchant creates a welcome promotion on the program and agrees to an additional welcome promotion rebate of $5.00. The merchant selects the rules for the welcome promotion to require the participant to use his program card on Tuesday to receive the welcome promotion rebate. A participant identifies $125 to be spent in Merchant's establishment. The participant uses his program card to purchase goods or services at the merchant's establishment $100 on Tuesday for his first purchase from the merchant. Accordingly, the participant's NPO receives the normal beneficiary's rebate plus the $5 welcome rebate. The IS>0 and the AS<IS, therefore:

| | |
|---|---|
| IS = $125.00 | ERP = 4.0% + 4.8% = 8.8% |
| AS = $100.00 | AR = 4.0% * $100 = $4.00 |
| EAS = $100.00 | BR = 4.8% * $100 = $4.80 |
| ARP = 4.0% | ER = $4.00 + $4.80 = $8.80 |
| BRP = [($100/$125) * (10.0% − | Lift = $100 − ($8.80/10%) = $12.00 |
| 4.0%)] = 4.8% | |
| WPR = $5.00 | |

### EXAMPLE #7

A Merchant creates a special promotion on the program and agrees to an additional special promotion percentage of 5%. The merchant selects the rules for the special promotion to require the participant to use his program card on Tuesday to receive the special promotion percentage. A participant identifies $125 to be spent with merchant. The participant then uses his program card to purchase goods or services from the merchant for $100.00 on Tuesday. Accordingly, the participant's NPO receives the normal beneficiary's rebate plus the special promotion rebate. The IS>0 and the AS<IS, therefore:

| | |
|---|---|
| IS = $125.00 | ERP = 4.0% + 4.8% = 8.8% |
| AS = $100.00 | AR = 4.0% * $100 = $4.00 |
| EAS = $100.00 | BR = 4.8% * $100 = $4.80 |
| ARP = 4.0% | ER = $4.00 + $4.80 = $8.80 |
| BRP = [($100/$125) * (10.0% − | Lift = $100 − ($8.80/10%) = $12.00 |
| 4.0%)] = 4.8% | |
| SRP = 5.0% | |
| SPR = 5.0% * $100 = $5.00 | |

It will be understood that the accurate identified spending reward plan can be otherwise configured to discourage inflating of identified spending. In one alternative embodiment, the accurate identified spending reward plan can include a logarithmic scale multiplier for excess actual spending. In this way, if a participant under spends by just a little, he generates a benefit that is greater than the percentage he has under-spent. But if the participant significantly under-spends, then he generates a benefit that is less than the percentage he under-spent.

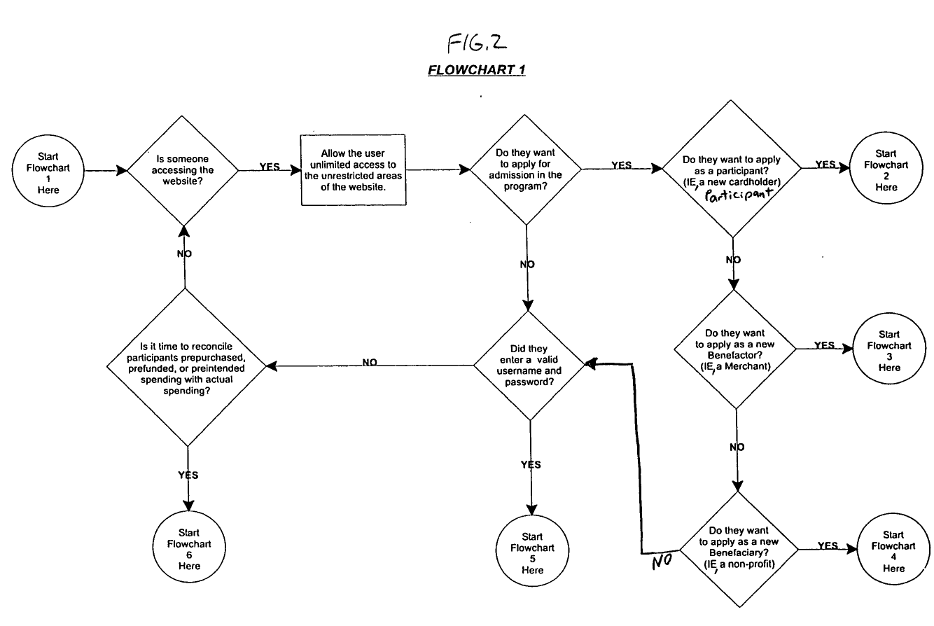

Having described in detail the major components of the affinity program 10 and the major components of the computer network 12 for implementing the program 10, the general operation and administration of the program will now be described with reference to a series of flowcharts. FIGS.2-33 are flowcharts illustrating the process flow programmed into the main computer 14 for operating a website for administering the program 10. It will be understood that the flowcharts are intended only to show one example of the program of the present invention, and that the invention includes numerous variations that can be made when implementing the program.

The numbering of the flowcharts indicates the relationship of that flowchart to other flowcharts. For example, Flowchart 5A3A is a subroutine identified in Flowchart 5A3, which is a subroutine identified in Flowchart 5A, which is a subroutine identified in Flowchart 5. Similarly, Flowchart 5A and Flowchart 5B are subroutines that are also identified in Flowchart 5. By noting the Flowchart numbers, the reader can more easily follow the process flow.

In addition, each flowchart begins at the circle including the words “START FLOWCHART HERE.” A circle including the words “RESTART FLOWCHART HERE” indicates that the process continues at the beginning of the same flowchart. And a circle including the words “START FLOWCHART XXX HERE” , where “XXX” is a flowchart number, indicates that the process continues at the beginning of the identified flowchart. Noting the use of these directional terms will aid in navigating the various flowcharts.

The flowcharts include detailed descriptions of each step of the process and are self-explanatory to a person of ordinary skill in the art. For added clarity, however, a general description of each flowchart will now be provided.

FIG. 2 (Flowchart 1) shows the “Accessing the Website” process. This flow diagram shows the process that identifies and allows non-participants, participants (i.e., consumers), benefactors (i.e., merchants), and beneficiaries (i.e., NPOs) to access and navigate appropriate areas of the website. Non-participants can access the website but are limited to the unrestricted areas, which include general information on the program and functions for becoming a participant, merchant, or beneficiary. The participants, merchants, and beneficiaries can log onto the website and enter their username and password to access their particular protected area.

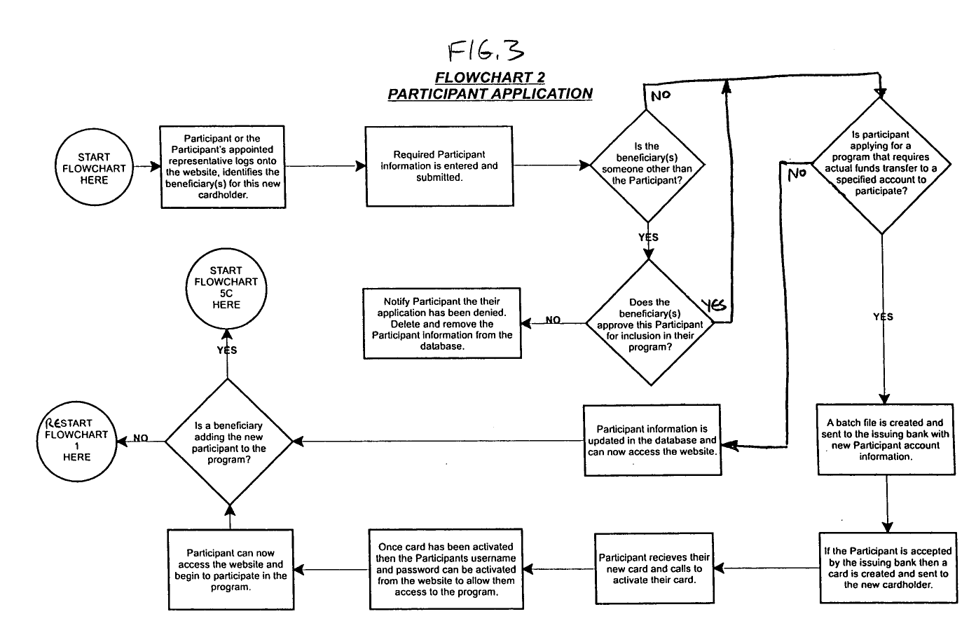

FIG. 3 (Flowchart 2) shows the “Participant Application” process. This flow diagram shows the process for an individual or appointed representative to establish an account for participating in the program, i.e., to become a participant. A prospective participant applies for an account, establishes who the beneficiary(ies) associated with the account will be, and is accepted or rejected by the beneficiary.

If the participant is applying for Plan “A” of the program, which requires advance cash transfers before identifying pre-purchased, pre-funded, or pre-intended purchases, then a card account is set up and the participant is issued his card. Once the participant activates his card for use he gains access to the administration web site. If the participant is applying for Plan “B” of the program, which does not require advance cash transfers, then he does not need a card, and once entered into the system he has immediate access to the website.

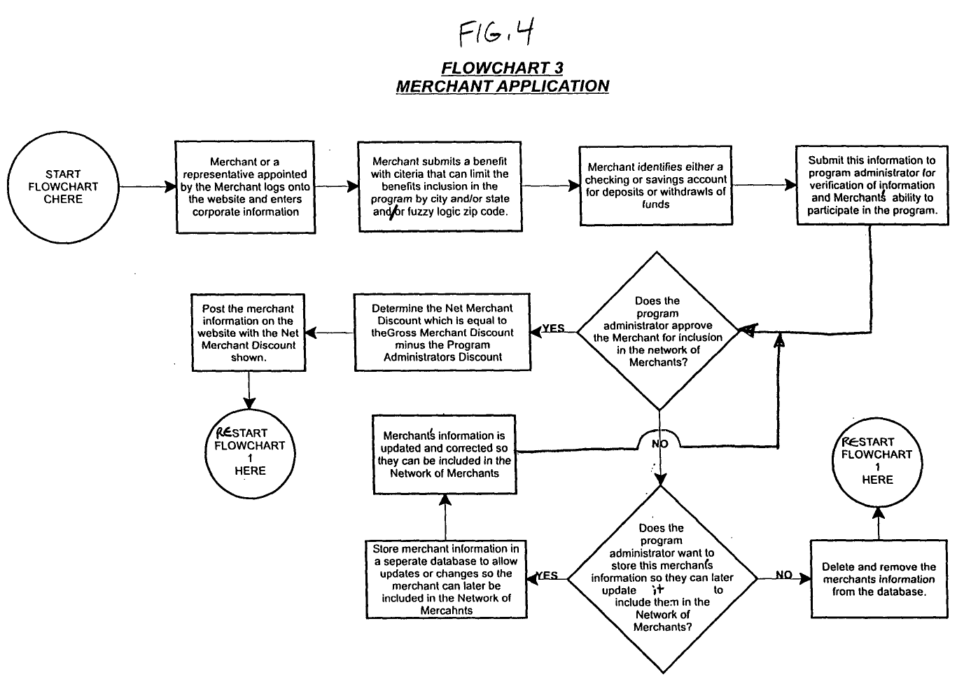

FIG. 4 (Flowchart 3) shows the “Merchant Application” process. This flow diagram shows the process for a merchant to apply for participation in the program and be included in the Network of Merchants. A merchant that desires to participate in the program can log onto the website and set itself up for approval or it can contact a program administrator who sets them up.

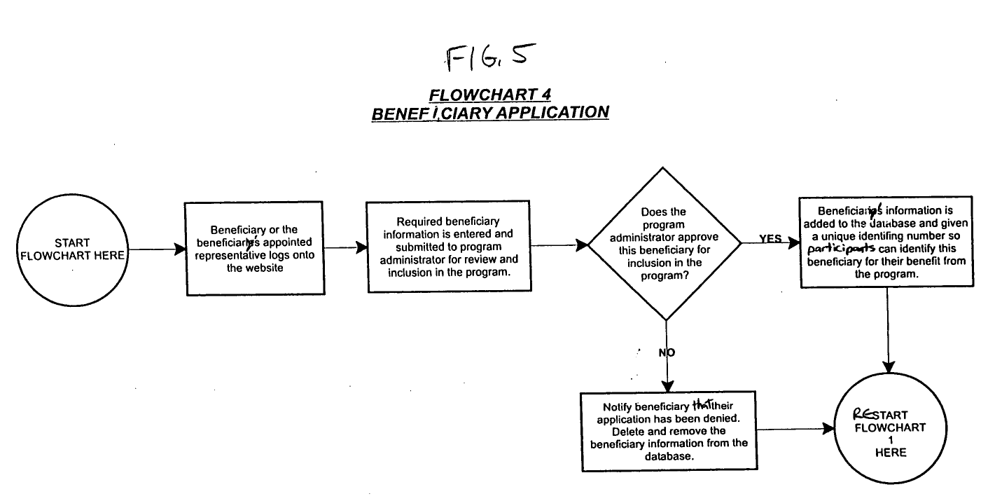

FIG. 5 (Flowchart 4) shows the “Beneficiary Application” process. This flow diagram shows the process for a beneficiary to apply for participation in the program. A beneficiary, such as a nonprofit organization, that desires to participate in the program can log onto the website and set itself up for approval or it can contact a program administrator who sets them up.

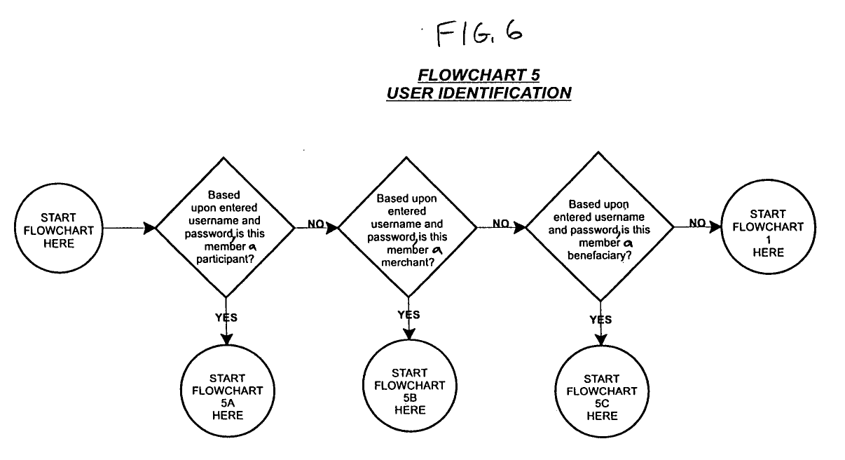

FIG. 6 (Flowchart 5) shows the “User Identification” process. This flow diagram shows the process for identifying a website user as a particular participant, merchant, or beneficiary based on the username and password entered. If a participant attempts to access the program, he will be directed to his secure area. If a merchant attempts to access the program, it will be directed to its secure area. And if a beneficiary attempts to access the program, it will be directed to its secure area. The program provides security so that only an authorized user can access its protected area.

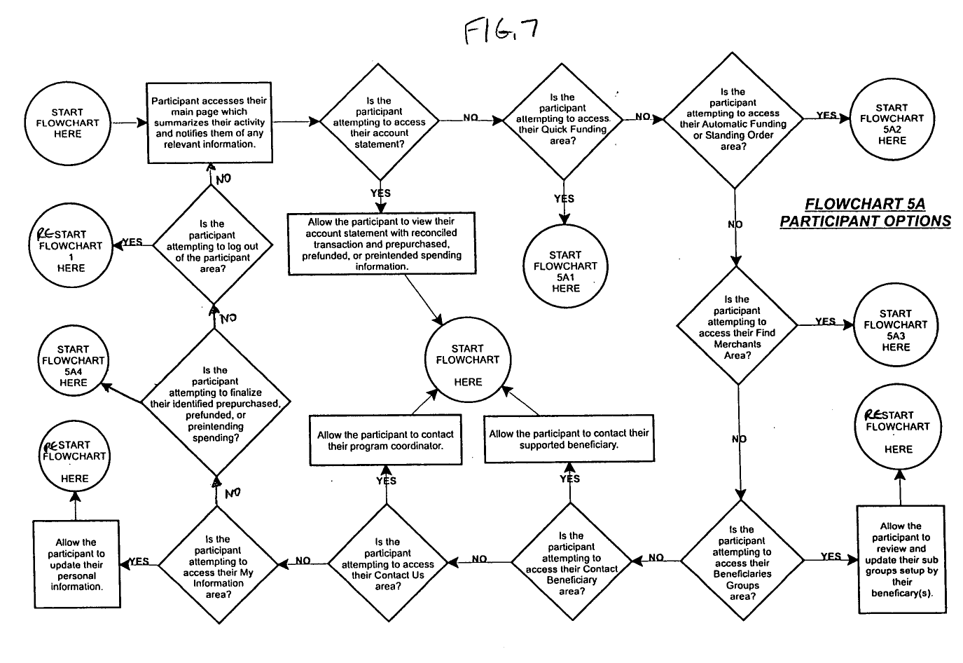

FIG. 7 (Flowchart 5A) shows the “Participant Options” process. This is a top-level flow diagram showing the process of allowing the participant to select from the various options available once he has accessed his portion of the program. The options may include areas relating to, for example, the participant's account statement, Quick Funding, Automatic Funding/Standing Orders, Find Merchants, Beneficiary Groups, a Contact Area, and updating his personal information.

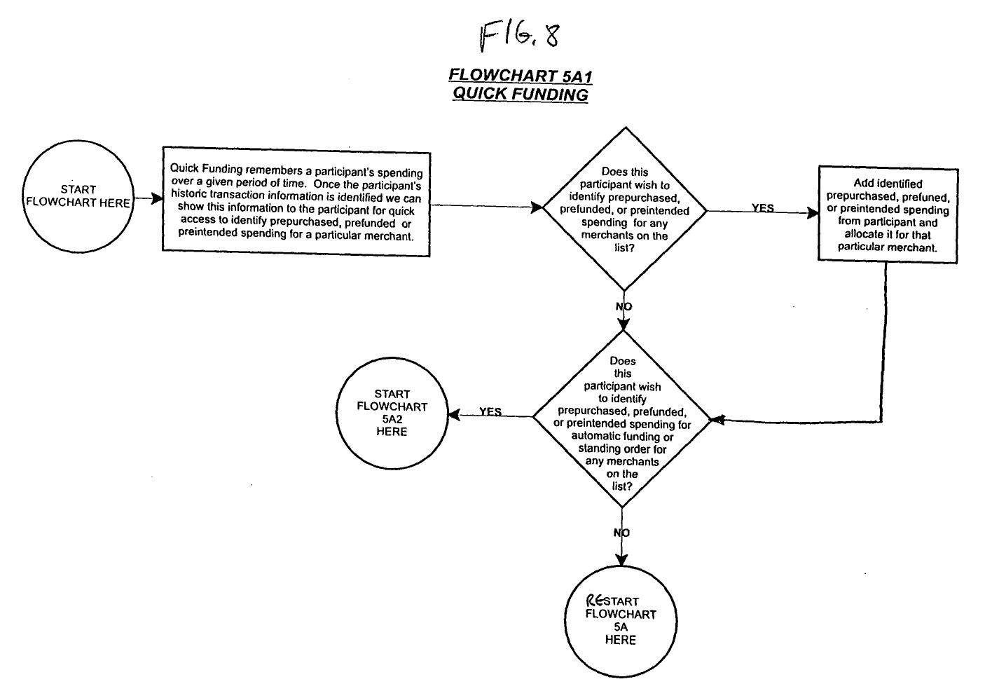

FIG. 8 (Flowchart 5A1) shows the “Quick Funding” process. This flow diagram shows the process whereby the system remembers a participant's actual spending at certain merchants over a given period of time and provides a website area listing those merchants. Because the participant has conducted transactions with these particular merchants in the past, the participant may want to conduct transactions with these merchants in the future. When the participant logs onto the website an area is available for “Quick Funding.” The participant can use this area to quickly and easily select a merchant from any of the included merchants and then identify spending in that merchant's purse. To identify spending with several merchants, the participant can save the identified spending for the selected merchant in his shopping cart and then identify spending for other merchants on the list.

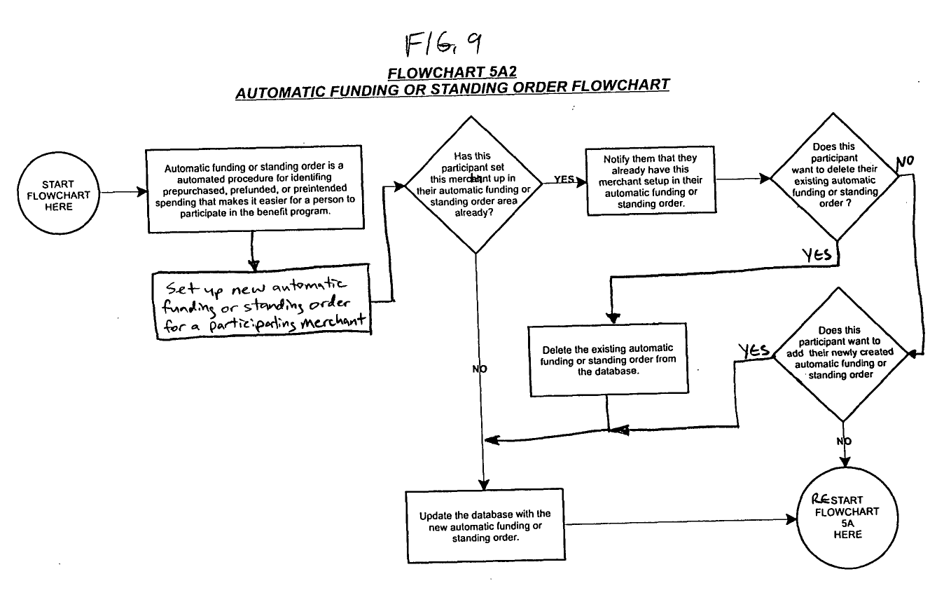

FIG. 9 (Flowchart 5A2) shows the “Automatic Funding/Standing Order” process. This flow diagram shows the process whereby a participant designates specific merchants' purses that are automatically identified for pre-purchased, pre-funded, or pre-intended spending on set days on a weekly, monthly, or other basis. Ordinarily the participants would have to log onto the website every time they want to select a merchant and identify spending with that merchant. To make it easier to participate in the program, the participant can set up automatic funding/standing orders to identify spending in specific merchant purses and, if necessary, to automatically fund the merchant purses at a particular time on a regular, repeating basis. To set up automatic funding/standing orders with several merchants, the participant can save the automatic funding/standing order for the selected merchant in his shopping cart and then set up automatic funding/standing orders for other merchants. In this way, the participant does not have to log onto the website for regular, predictable purchasing. And the merchants can track and measure this pattern, allowing them to better predict needed inventory and to tailor their dynamic marketing efforts.

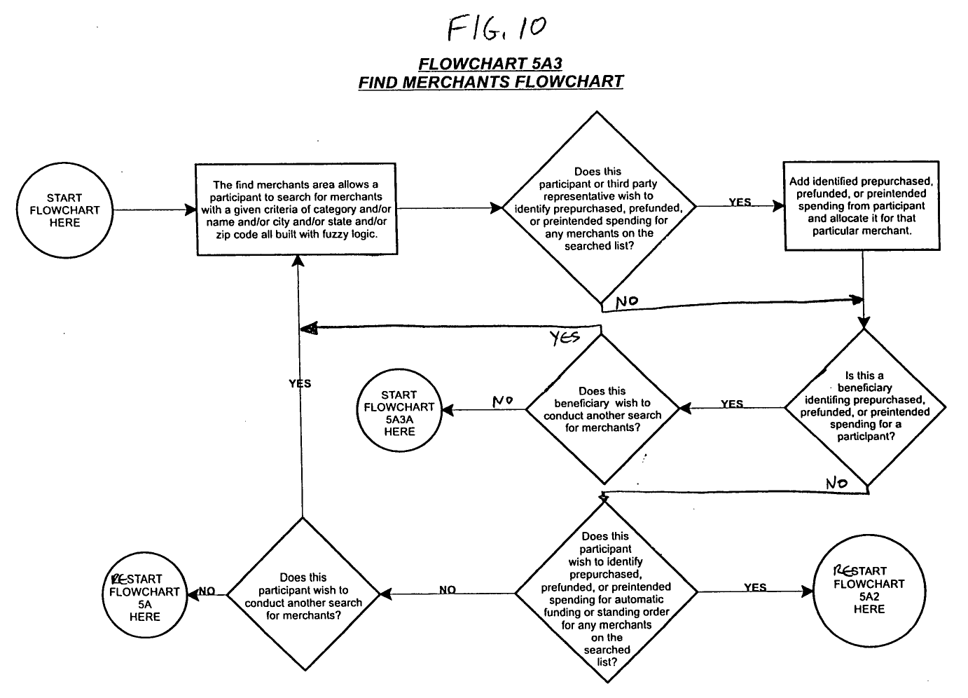

FIG. 10 (Flowchart 5A3) shows the “Find Merchants” process. This flow diagram shows the process by which the participants ordinarily select merchants for pre-purchased, pre-funded, or pre-intended spending. The participant can log onto the website to conduct a search for a specific merchant, type of merchant (i.e., video rental store), location, combination of these parameters, etc. Then the participant can identify pre-purchased, pre-funded, or pre-intended spending directed to specific merchant purses and/or to his general purse. To identify spending with several merchants, the participant can save the identified spending for the selected merchant in his shopping cart and then search and identify spending for other merchants. In addition, if the beneficiary is identifying the pre-purchased, pre-funded, or pre-intended spending for the participant, then the beneficiary can conduct the merchant searching.

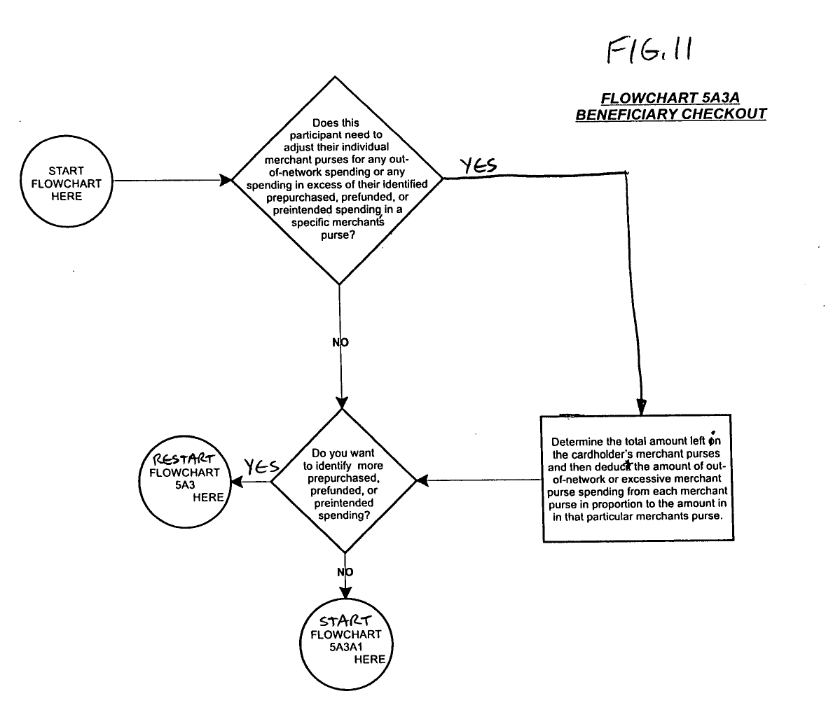

FIG. 11 (Flowchart 5A3A) shows the “Beneficiary Checkout” process. This flow diagram shows the process for a third party user to identify pre-purchased, pre-funded, or pre-intended spending to a participant's account. Private participant information is not exposed to the third party. This feature permits a third party, such as a non-profit coordinator, to log onto the website and conduct an identified pre-purchased, pre-funded, or pre-intended spending transaction directed to specific merchant purses.

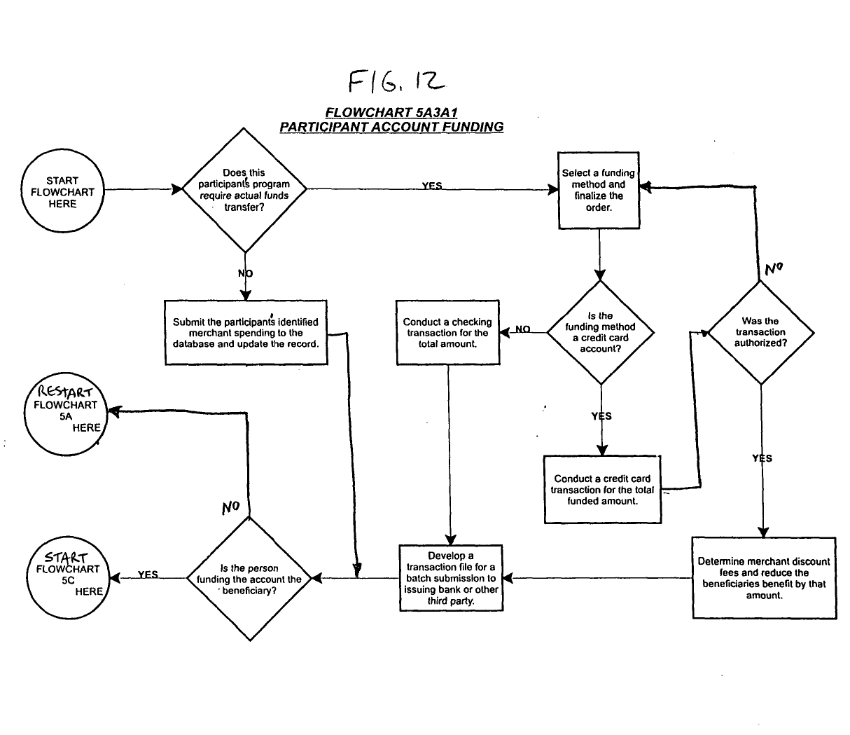

FIG. 12 (Flowchart 5A3A1) shows the “Participant Account Funding” process. This flow diagram shows the process for a participant or identified third party to finalize the identified pre-purchased, pre-funded, or pre-intended spending and, if required, transfer the needed funds to the participant's account. The advance transfer of funds is typically required under Plan “B” of the program, and is typically not necessarily required under Plan “B” of the program.

The participant can log onto the website to conduct an identified pre-purchased, pre-funded, or pre-intended spending transaction and direct spending to specific merchant purses and/or to their general purse. If required, the participant then designates which form of payment he will use to finalize the process and transfer the funds to his account. Once this is completed, the participant's account information is updated.

In addition, a third party user can log onto the website to conduct an identified pre-purchased, pre-funded, or pre-intended spending transaction and direct spending to specific merchant purses and/or to a participant's general purse. If required, the third party then designates which form of payment it will use to finalize the process and transfer the funds to the participant's account. Once this is completed, the participant's account information is updated.

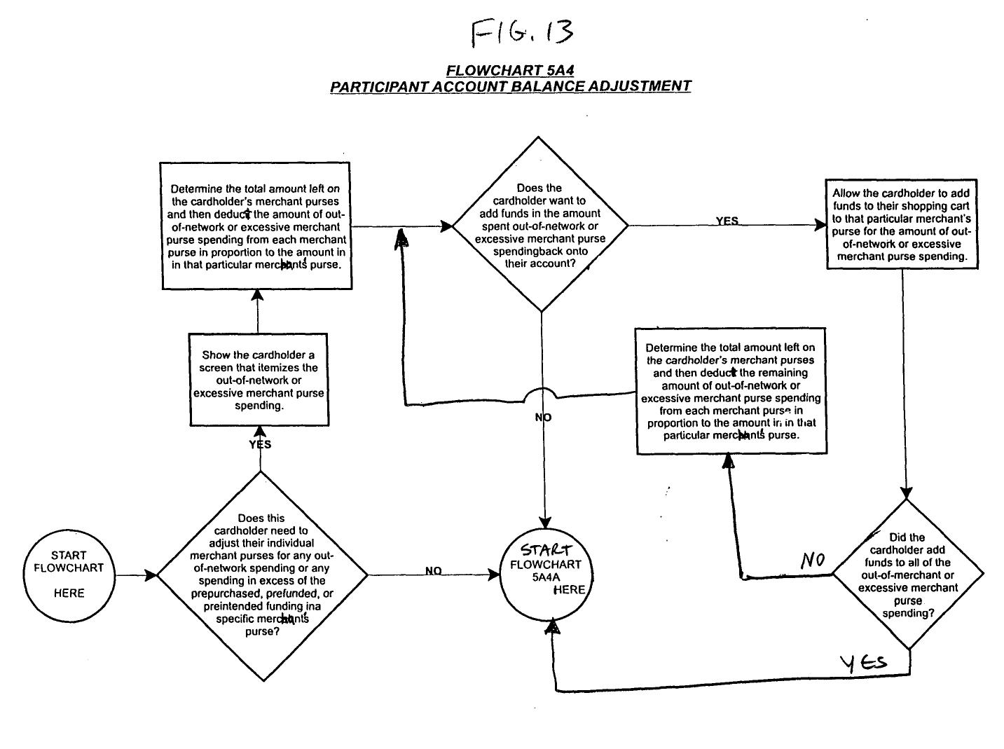

FIG. 13 (Flowchart 5A4) shows the “Participant Account Balance Adjustment” process. This flow diagram shows the process for a participant to adjust identified pre-purchased, pre-funded, or pre-intended spending in their account, if adjustments to specific merchant purses are necessary or desired. This adjustment is a component of the system of tracking and matching the identified pre-purchased, pre-funded, or pre-intended spending with the actual spending transactions.

The Participant Account Balance Adjustment process allows the participants to adjust the identified spending amounts in the merchant purses when the participant's actual spending does not approximate what he expected. In particular, a participant can decrease the identified spending amounts in one or more merchant purses and increase by the same amount the identified spending amounts in one or more other merchant purses. So if the participant ends of making a purchase at one merchant that he expected to make at another merchant, he can adjust his account accordingly.

Under Plan “A” of the program, the account adjustment process is typically limited so that the participant is allowed to make any desired adjustments amongst merchant purses as long as the total amount of identified spending is funded in the account. That is, any adjustment is permitted as long as the merchant purses collectively have a total identified pre-purchased, pre-funded, or pre-intended spending equal to the original identified spending amount minus the actual transaction spending plus any new identified spending amount. This limitation of adjustments is typically included under Plan “A” in order to prevent the participants from over-inflating their identified spending at a merchant, which they might otherwise be tempted to do in order to capture any spending at the merchant in excess of the identified spending amounts.

For example, say a participant had a total of $100 in its account, with $50 identified to be spent at Merchant #1 and $50 identified to be spent at Merchant #2. However, the participant needed to spend its money at Merchant #3, which either is not in the network of merchants or had no identified spending allocated to it prior to the actual transaction. Say the participant spent $75 at Merchant #3. Now the participant needs to adjust the identified spending allocated to Merchant #1's purse and to Merchant #2's purse since their identified purse money was instead spent at Merchant #3. If Merchant #3 is in the network of merchants, then the participant could just add $75 from his general purse to Merchant #3's purse. Or the participant could borrow $37.50 each from Merchant #1's purse and Merchant #2's purse to add to Merchant #3's purse to balance the account. In fact, the participant could make any desired adjustment amongst merchant purses as long as the merchant purses collectively have a total identified spending amount equal to the original identified spending amount ($100) minus the actual transaction spending ($75) plus any newly added identified spending amount.

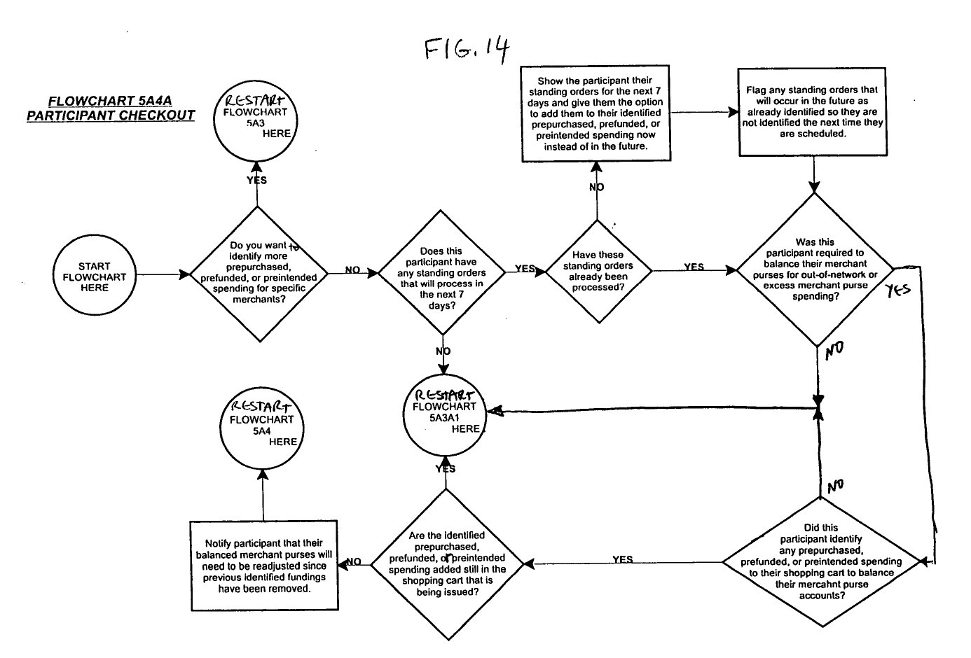

FIG. 14 (Flowchart 5A4A) shows the “Participant Checkout” process. This flow diagram shows the process for a participant to finalize his identified pre-purchased, pre-funded, or pre-intended spending in their account. This process includes a unique feature that identifies any automatic funding/standing orders that will post in the upcoming days, say, in the next week, and allows the participant to identify those pre-purchased, pre-funded, or pre-intended spending amounts now instead of in the future. This feature makes the process of participating in the program easier.

In particular, the participant logs onto the website and identifies pre-purchased, pre-funded, or pre-intended spending in specific merchant purses. At checkout, the system checks to see if the participant has any automatic funding/standing orders that are scheduled to occur within a predetermined time period, and displays a screen asking the participant if he would like to process any of the automatic funding/standing orders at this time. If the participant chooses to do so, then those selected automatic funding/standing orders are processed now and flagged by the system so they will not post in the future.

In addition, the checkout process can include displaying a confirmation screen showing all of the selected merchants and the identified spending in those merchant's purses from the shopping session. Furthermore, this checkout screen can include links to the websites of the selected merchants to facilitate online shopping and actual spending with those merchants having an online presence.

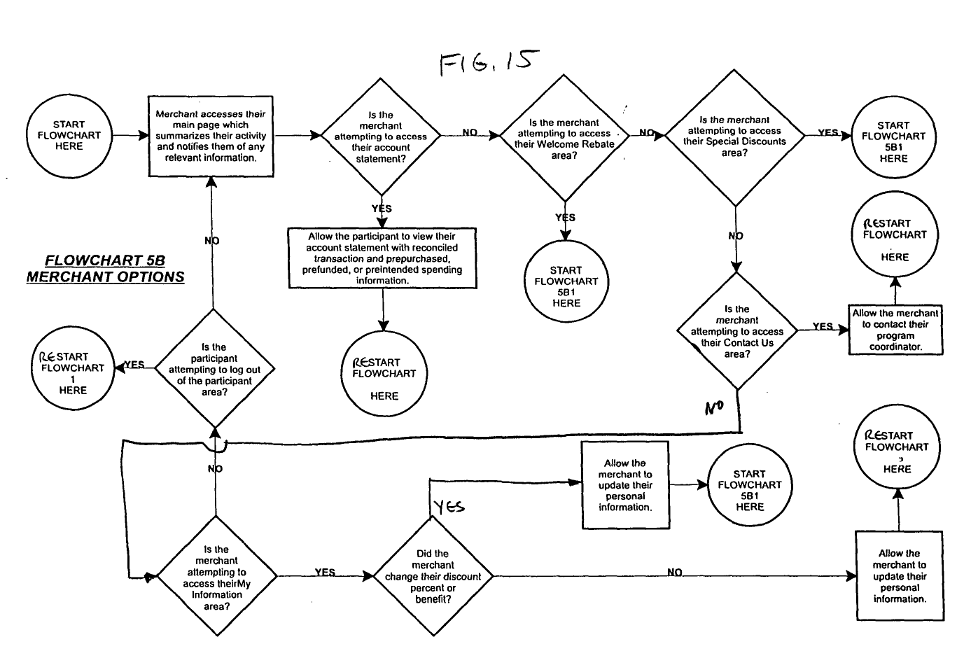

FIG. 15 (Flowchart 5B) shows the “Merchant Options” process. This is a top-level flow diagram showing the process of allowing the merchant to select from the various options available once it has accessed its portion of the program. The options may include areas relating to, for example, the merchant's account statement, creating welcome rebates, creating special discounts, a Contact Area, and updating the merchant information.

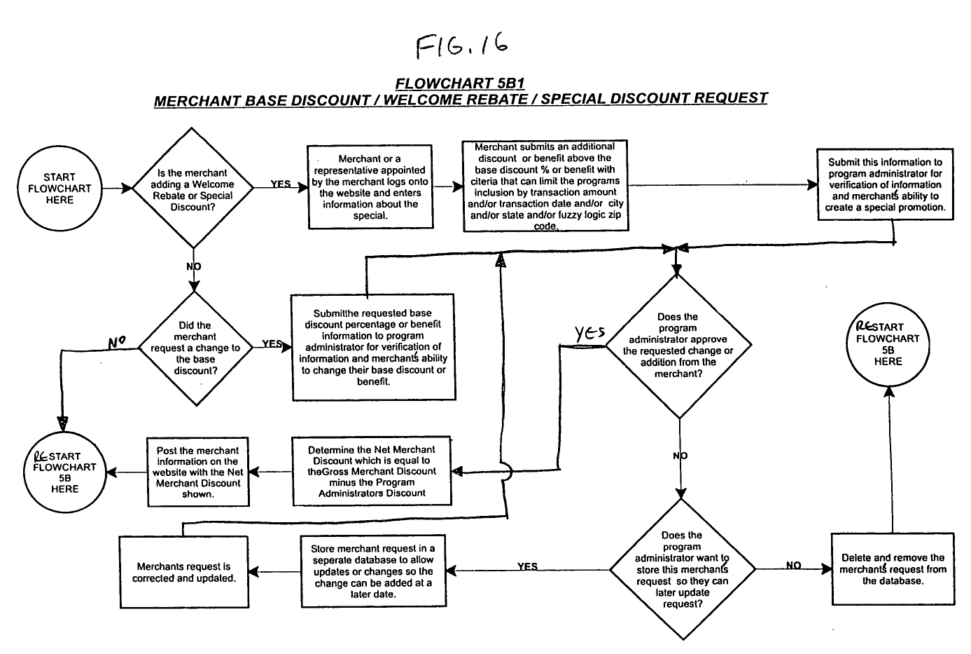

FIG. 16 (Flowchart 5B1) shows the “Merchant Base Discount/Welcome Rebate/Special Discount” processes. This flow diagram shows the process for a merchant to create a new benefit or update an old benefit. Because of the tracking and measuring of identified spending relative to actual spending that is provided by the program, the merchants can create tailored dynamic marketing specials.

The Merchant Base Discount process allows a merchant to access the website and submit a request to change its NRP, for example, from 10% to 8%. The request is submitted to the program administrator for review and approval prior to inclusion of the changed NRP in the program.

The Welcome Rebate process allows a merchant to create a promotional welcome rebate for new customers. For example, a merchant might know that for a typical customer the average ticket price per visit is $75. The merchant could offer a welcome rebate that gives the beneficiary a $15 benefit if the participant identifies $150 of spending at its store and actually transacts a $150 purchase. But if the participant actually spent only $130 and not the identified $150 amount, then the merchant had an above-average ticket price for this customer without having to pay the benefit.

Once the participant shopped in the merchant's store the first time the welcome rebate would no longer be available to that participant. Because of the tracking capabilities, the merchant can determine whether a participant is a new customer or has purchased from it previously.

The program allows the merchant to limit the benefit to predetermined transactions, for example, to transactions of a certain amount, on a certain day or range of days, and/or in a certain city, state, and/or zip code, all with fuzzy logic if desired. The merchant submits the welcome rebate offer request using the website, and it is submitted to the program administrator for review and approval prior to inclusion in the program.

The Special Discount process allows a merchant to create a special promotion rebate. Using the program, the merchant can create a special discount offer that gives the participants an additional benefit above the regular base discount under certain conditions. For example, a merchant might know that Tuesday night is a very slow night for it and so the merchant would like to generate more customer traffic on Tuesdays. The merchant can create a special discount that gives any participant an additional benefit if the participant identifies spending with the merchant on a Tuesday night and then actually conducts the transaction on Tuesday night. Because of the tracking capabilities provided by the program, the merchant can measure the value of participating in the program and better tailor its special discounts.

The program allows the merchant to limit the benefit to predetermined transactions, for example, to transactions of a certain amount, on a certain day or range of days, and/or in a certain city, state, and/or zip code, all with fuzzy logic if desired. The merchant submits the special discount request using the website, and it is submitted to the program administrator for review and approval prior to inclusion in the program.

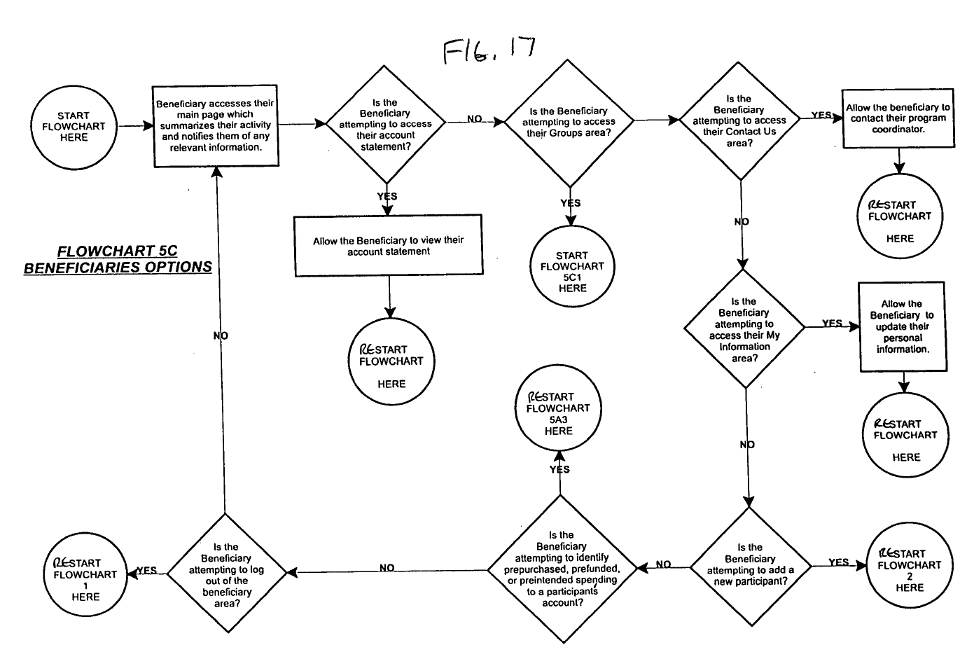

FIG. 17 (Flowchart 5C) shows the “Beneficiaries Options” process. This is a top-level flow diagram showing the process of allowing the beneficiary to select from the various options available once it has accessed its portion of the program. The options may include areas relating to, for example, the beneficiary's account statement, creating sub-groups, a Contact Area, adding a new participant that will be a supporter of the beneficiary, identifying pre-purchased, pre-funded, or pre-intended spending for specific merchants, and updating the beneficiary information.

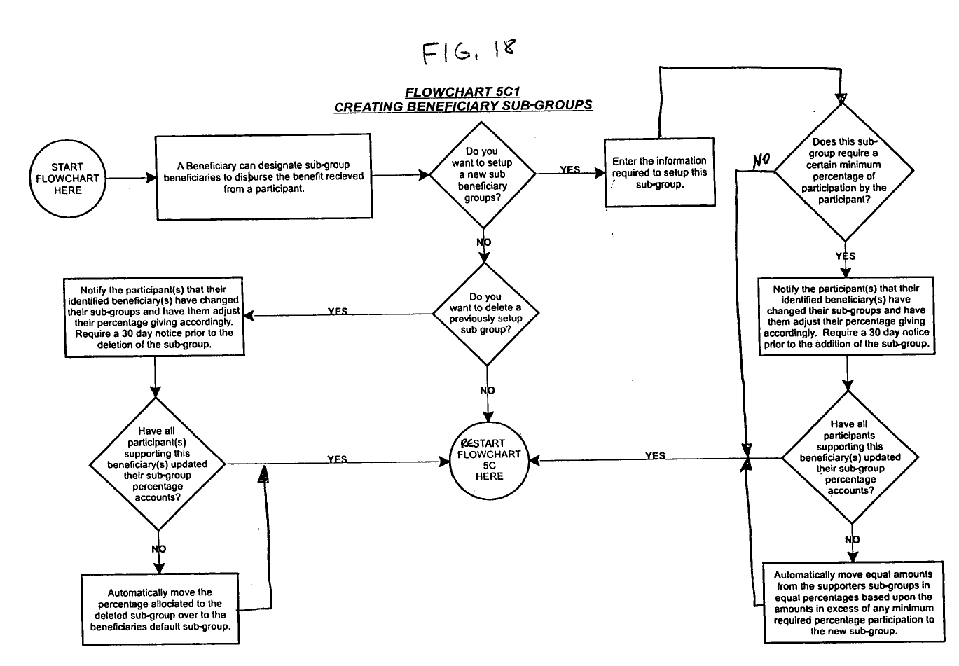

FIG. 18 (Flowchart 5C1) shows the “Creating Beneficiary Sub-Groups” process. This flow diagram shows the process for a beneficiary, such as an NPO, to designate sub-group beneficiaries to receive the benefit disbursed from a participant's purchases. The participants can then select not just the beneficiary but also a particular sub-group of the beneficiary that the participant wants to receive the benefit from its spending. The process allows the beneficiary to add and delete sub-groups as may be needed, and to provide a notice period such as 30 days for participants to change their account settings to remove a deleted sub-group. This feature makes the program easier for the beneficiary's representative to administer and allows them more flexibility in using the program.

For example, a school that is a participating beneficiary can setup a number of sub-groups in addition to or alternatively to the school's general account. The sub-groups could include, for instance, band, football, soccer, basketball, volleyball, and/or choir groups. The participants that support the school could then designate their benefits to go to one of the specific sub-groups.

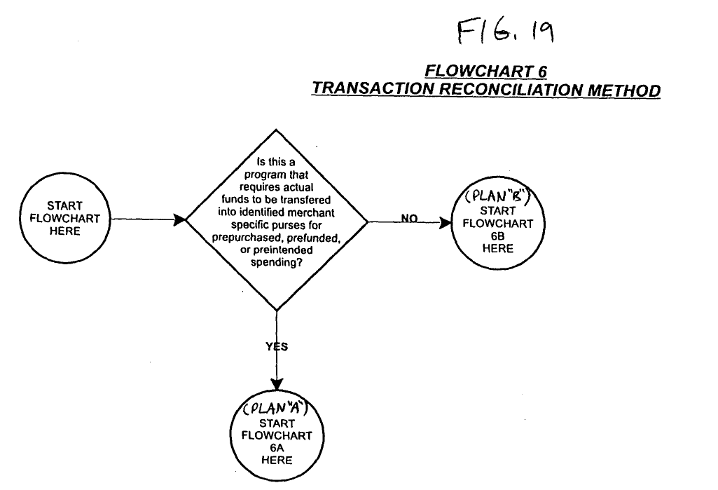

FIG. 19 (Flowchart 6) shows the beginning of the “Transaction Reconciliation” process. This flow diagram showing the process of determining whether the transaction is to be reconciled under Plan “A,” which requires advance funding, or under Plan “B,” which does not. For Plan “A” the transaction reconciliation process is shown in the “6A” flowchart series, and for Plan “B” the transaction reconciliation process is shown in the “6B” flowchart series.

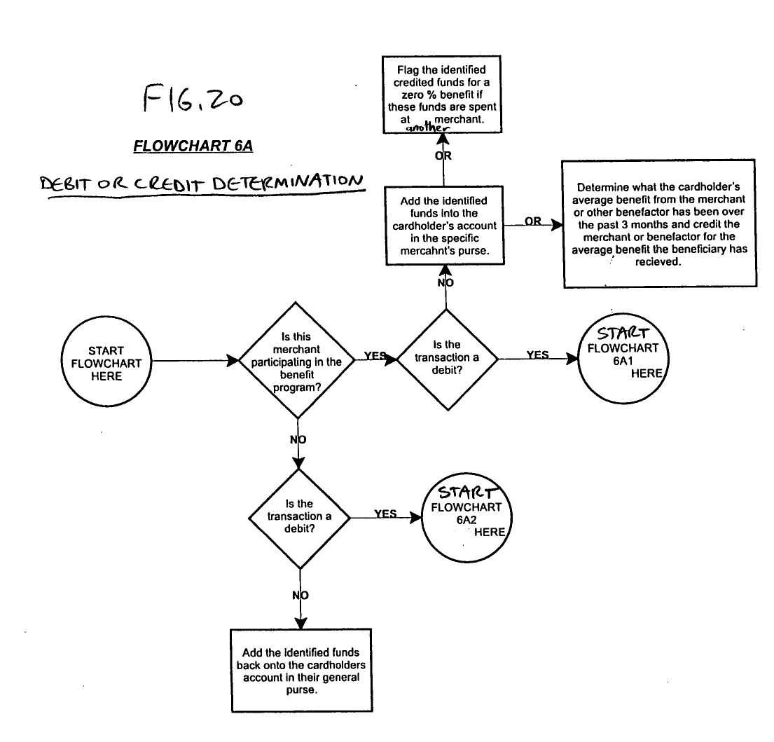

FIG. 20 (Flowchart 6A) shows the “Debit or Credit Determination” process for Plan “A.” This flow diagram shows the process for applying a merchant credit to a participant's account. When a participant identifies spending with a merchant and actually spends with the merchant, but then returns the purchased item to the merchant, the merchant credits the participant's account through the merchant's point of sale (POS) terminal. If the identified funds are not later spent with the merchant, the beneficiary does not get any benefit. As an option, the program can be set up to credit the merchant based on an average benefit paid to the participant's beneficiary over a predetermined period of time, for example, the past 3 months. In addition, this flow diagram shows the process of checking each transaction to determine if the merchant participates in the program.

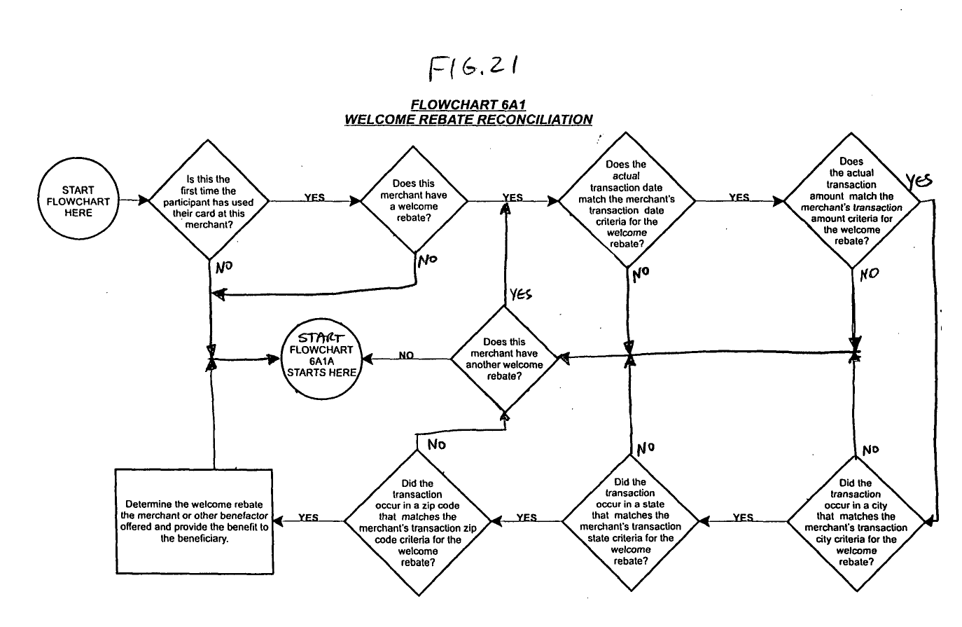

FIG. 21 (Flowchart 6A1) shows the “Welcome Rebate Reconciliation” process for Plan “A.” This flow diagram shows the process for determining if a benefit is due a beneficiary for a merchant's “Welcome Rebate” based on a participant's actual spending reconciled with its identified pre-purchased, pre-funded, or pre-intended spending. The process evaluates whether the welcome rebate conditions selected by the merchant have been met by the actual purchase and, if they have, determines the rebate benefit according to Plan “A.”

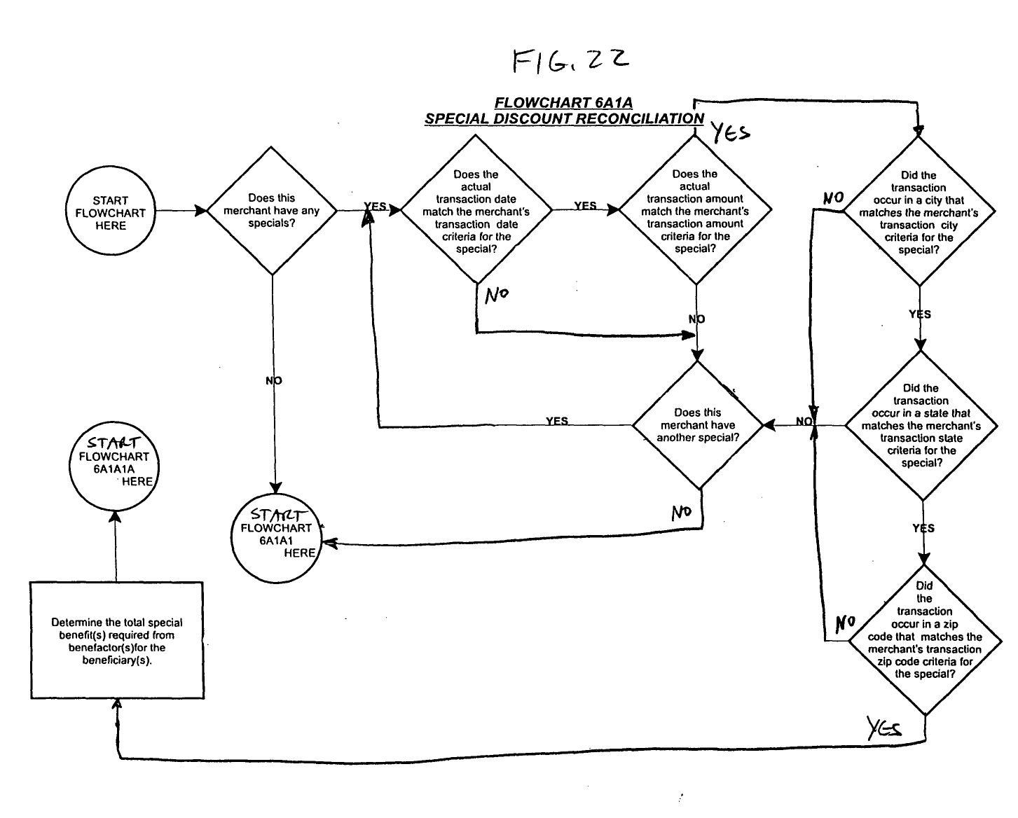

FIG. 22 (Flowchart 6A1A) shows the “Special Discount Reconciliation” process for Plan “A.” This flow diagram shows the process for determining if a benefit is due a beneficiary for a merchant's “Special Discount” based on a participant's actual spending reconciled with its identified pre-purchased, pre-funded, or pre-intended spending. The process evaluates whether the special discount conditions selected by the merchant have been met by the actual purchase and, if they have, determines the rebate benefit according to Plan “A.”

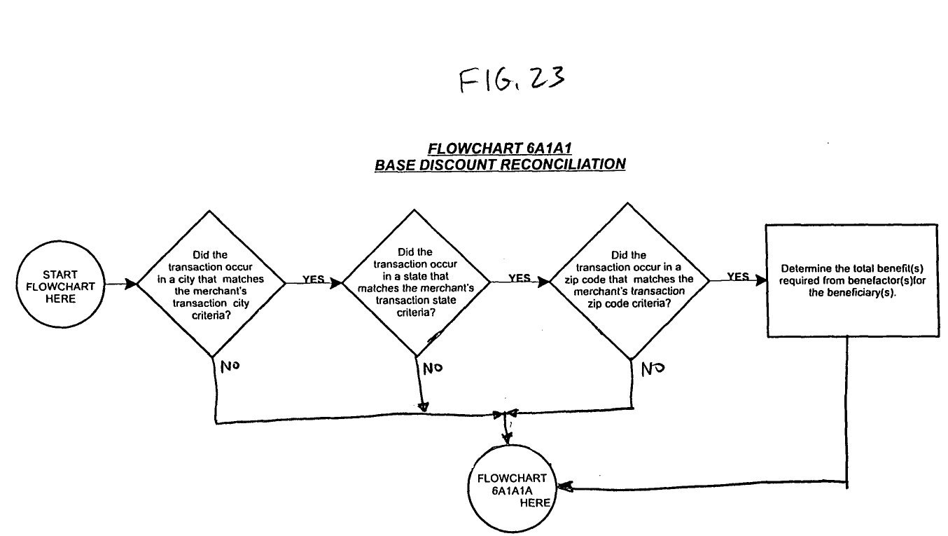

FIG. 23 (Flowchart 6A1A1) shows the “Base Discount Reconciliation” process for Plan “A.” This flow diagram shows the process for determining if a benefit is due a beneficiary for a merchant's “base benefit” based on a participant's actual spending reconciled with its identified pre-purchased, pre-funded, or pre-intended spending. The process evaluates whether the base benefit conditions selected by the merchant have been met by the actual purchase and, if they have, determines the rebate benefit according to Plan “A.”

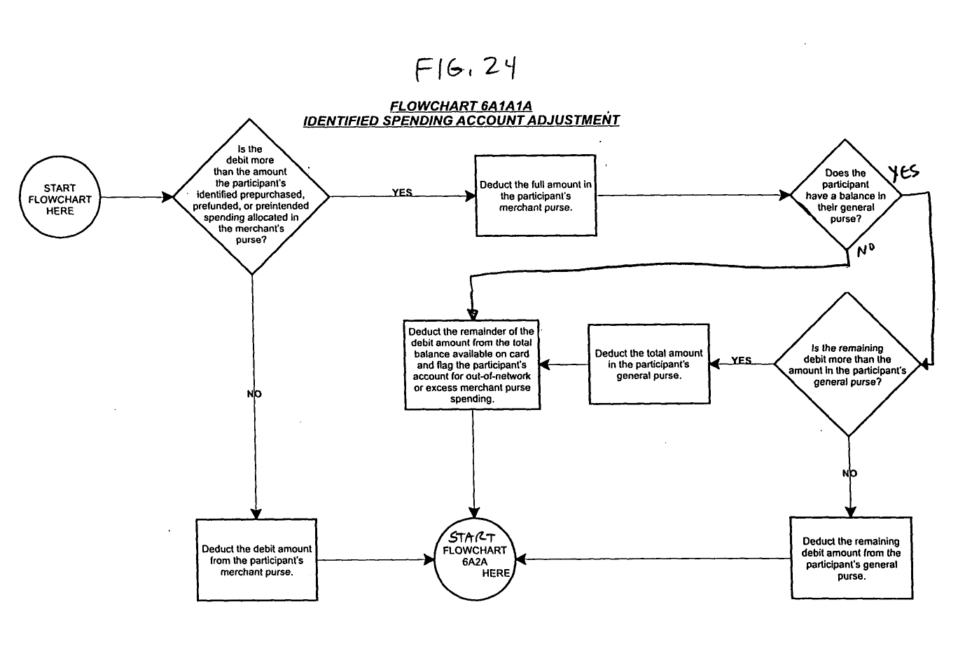

FIG. 24 (Flowchart 6A1A1A) shows the “Identified Spending Account Adjustment” process for Plan “A.” This flow diagram shows the process of adjusting a participant's specific merchant purses when an in-network transaction occurs at a participating merchant that is part of the network of merchants. When the participant conducts a sales transaction with the particular merchant, the amount actually spent is normally not exactly the same as the amount of identified spending. This process deducts the actual spending from the identified pre-purchased, pre-funded, or pre-intended spending accounts.

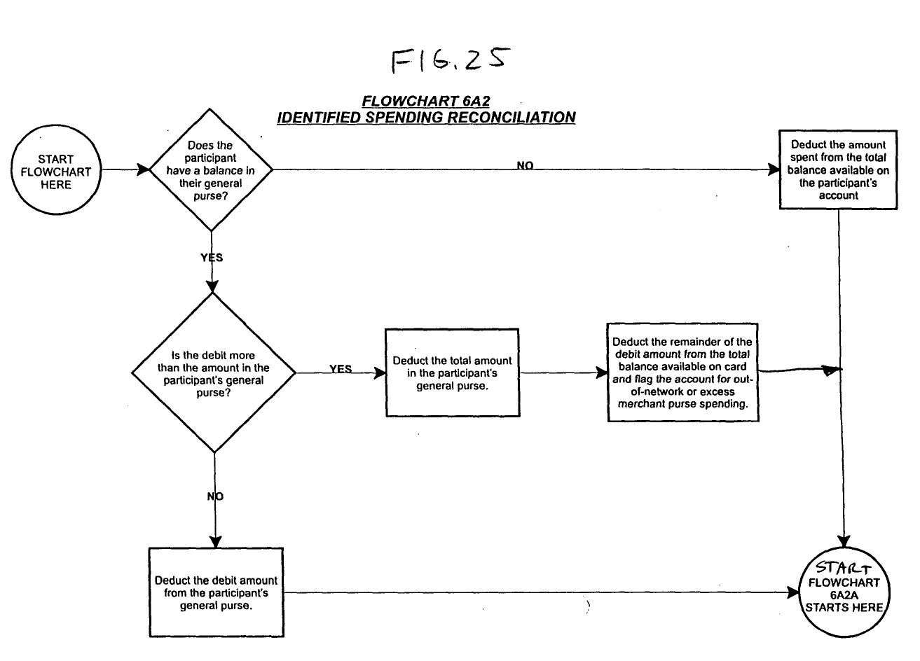

FIG. 25 (Flowchart 6A2) shows the beginning of the “Identified Spending Reconciliation” process for Plan “A.” This flow diagram shows the process of adjusting a participant's specific merchant purses when an out-of-network transaction occurs at a non-participating merchant that is not part of the network of merchants. When the participant conducts a sales transaction with the particular merchant, the amount actually spent is normally not exactly the same as the amount of identified spending. This process deducts the actual spending from the identified pre-purchased, pre-funded, or pre-intended spending accounts.

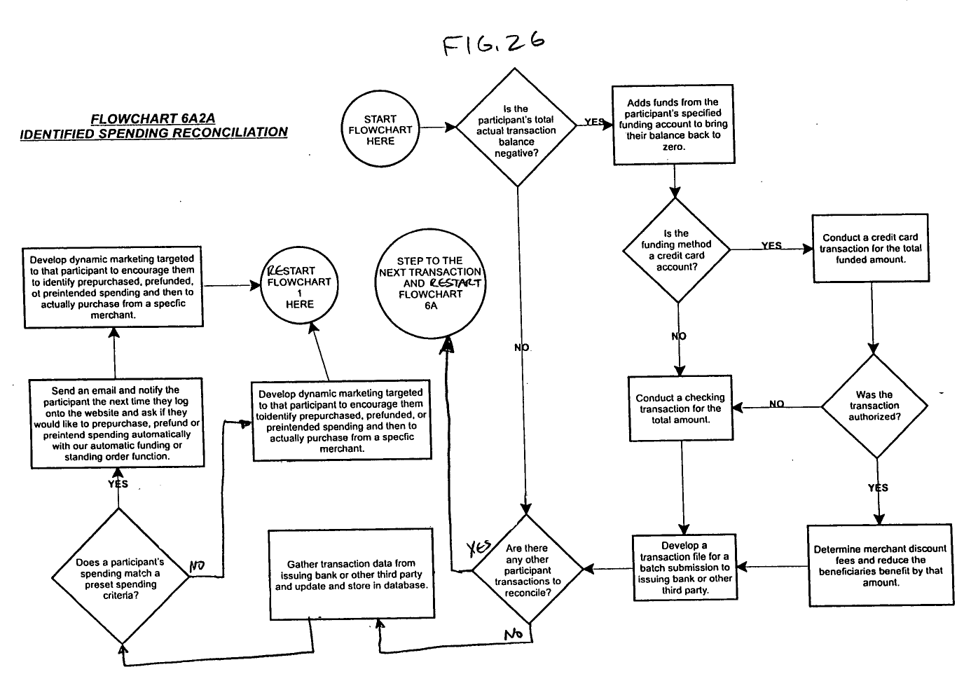

FIG. 26 (Flowchart 6A2A) shows the rest of the “Identified Spending Reconciliation” process for Plan “A.” This flow diagram shows the process of, after the transaction is processed by the system, conducting a query to determine if the account now has a negative balance and requires additional funding. The participant may conduct multiple transactions with multiple merchants in a given time period, say 24 hours. If the participant transacted a purchase for a larger amount than what was available in its account, then the program conducts an automatic funds transfer to bring the account balance back to zero. In addition, the process then checks to see if there are any other transactions to reconcile from the participant's account.

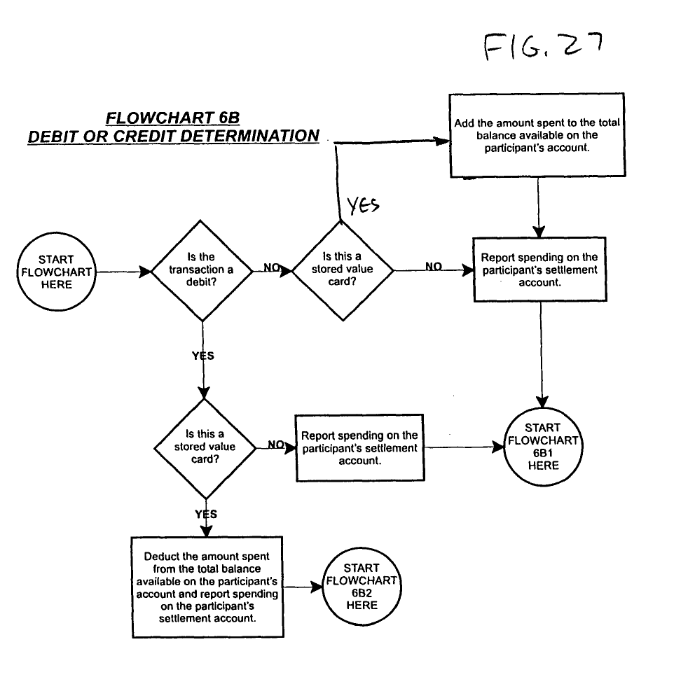

FIG. 27 (Flowchart 6B) shows the “Debit or Credit Determination” process for Plan “B.” This flow diagram shows the process of applying a merchant credit or debit to a participant's account. When a participant purchases an item from a merchant, the merchant debits the participant's account through the merchant's point-of-sale (POS) terminal. And when a participant returns an item to a merchant, the merchant credits the participant's account through the merchant's POS terminal.

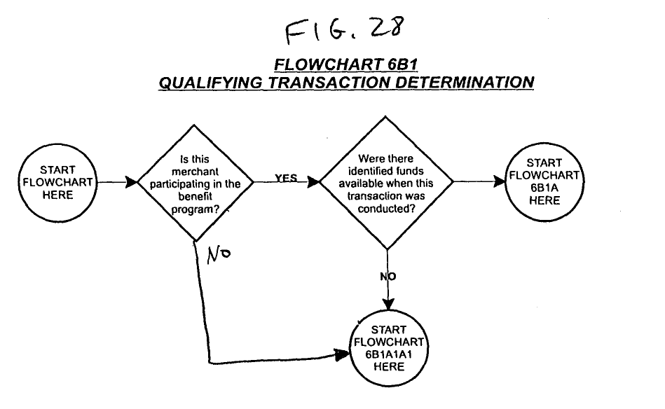

FIG. 28 (Flowchart 6B1) shows the “Qualifying Transaction Determination” process for Plan “B.” This flow diagram shows the process of checking each transaction to determine if the merchant participates in the program and if the participant had identified spending with the merchant.

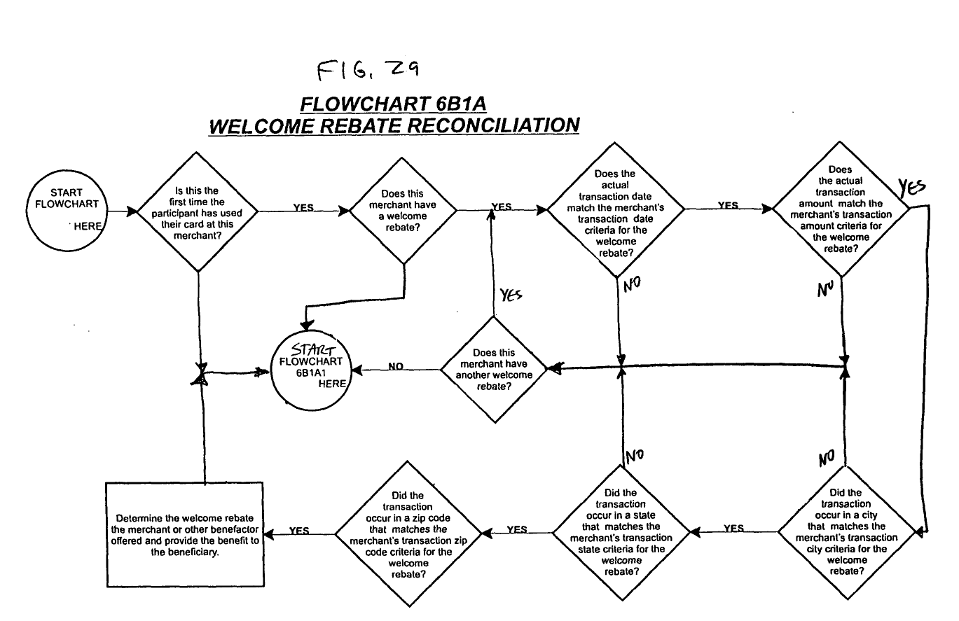

FIG. 29 (Flowchart 6B1A) shows the “Welcome Rebate Reconciliation” process for Plan “B.” This flow diagram shows the same general process shown in FIG. 21, Flowchart 6A1, but here the rebate benefit is determined under Plan “B.”

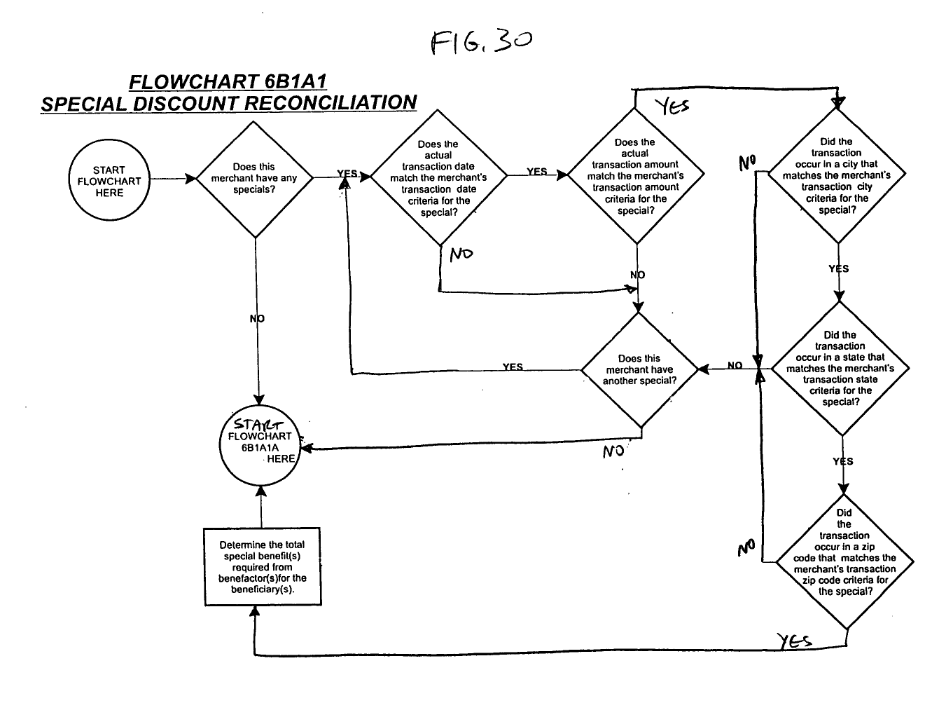

FIG. 30 (Flowchart 6B1A1) shows the “Special Rebate Reconciliation” process for Plan “B.” This flow diagram shows the same general process shown in FIG. 22, Flowchart 6A1A, but here the rebate benefit is determined under Plan “B.”

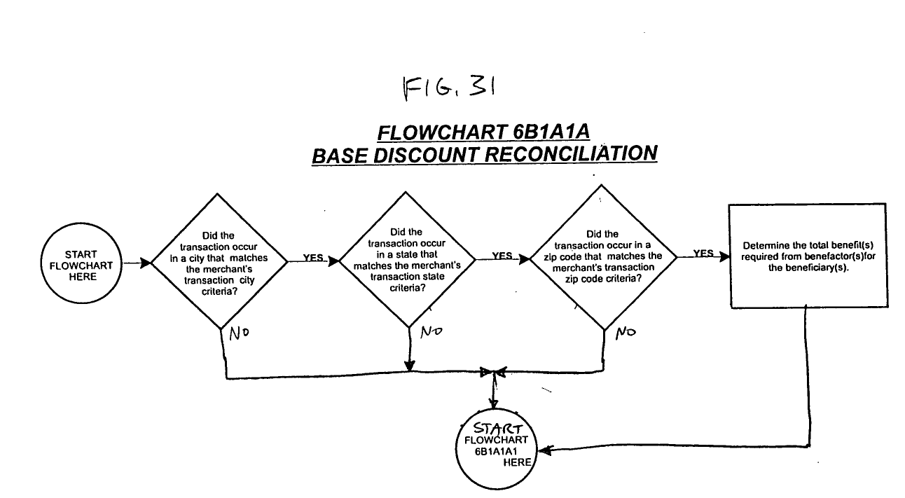

FIG. 31 (Flowchart 6B1A1) shows the “Base Discount Reconciliation” process for Plan “B.” This flow diagram shows the same general process shown in FIG. 23, Flowchart 6A1A1, but here the rebate benefit is determined under Plan “B.”

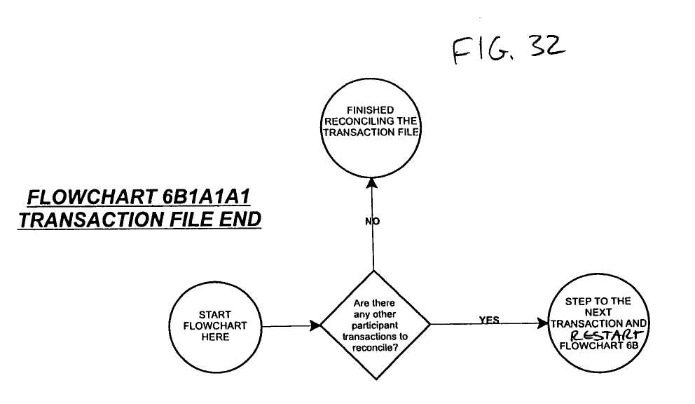

FIG. 32 (Flowchart 6BA1A1) shows the “Transaction File End” process for Plan “B.” This flow diagram shows the process of parsing all the data in the transaction file. The program checks to see if there are more transactions to reconcile. If so, it steps to the next transaction file. And if not, it ends the transaction reconciliation process.

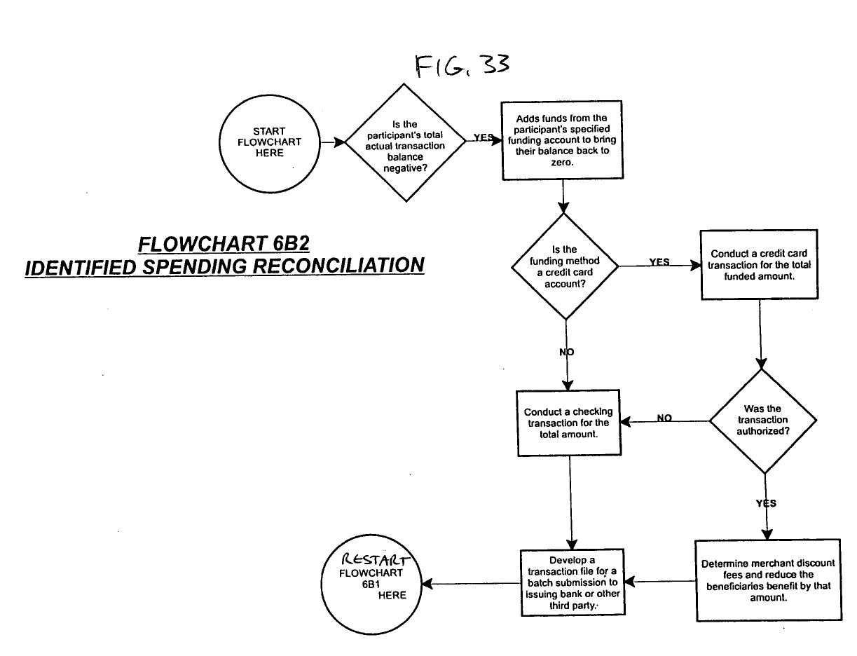

FIG. 33 (Flowchart 6B2) shows the “Identified Spending Reconciliation” process. This flow diagram shows a similar process as is shown in FIG. 26, Flowchart 6A2A.

At this point, all of the transactions have been processed by the “Transaction Reconciliation” process of the “6” series of flowcharts. The program then returns to the beginning by restarting Flowchart 1, displays a message indicating that all transactions have been processed and includes an area to logoff, or otherwise provides for concluding the website session.

The program 10 just described includes both the Plan “A” benefit determination method and the Plan “B” benefit determination method. In alternative embodiments of the present invention, the program includes only the Plan “A” benefit determination method, only the Plan “B” benefit determination method, another benefit determination method that discourages over-inflating of intended spending, or a combination of these methods.

Another alternative embodiment of the affinity program of the present invention includes the use of smart cards. A smart card has a very small “computer chip” embedded on the card. The chip can handle some of the processes that are otherwise transacted on the program servers. This embodiment can be considered a “virtual smart card technology” since the program has the ability to virtually do smart card technology but still rides the existing transaction network without requiring new point-of-sale devices. Unfortunately, smart card technology is not yet widely accepted, in part because it requires replacement of existing point-of-sale devices at merchant locations. Nevertheless, the program of the present invention can be readily adapted for implementation on smart cards to mimic the program of the exemplary embodiment. This adapted version of the program, implemented on a computer-readable storage medium on a smart card, is intended to be within the scope of the present invention. And in another alternative embodiment, the program includes a closed loop environment that only allows acceptance at specific merchants.

In view of the foregoing, it will be appreciated that present invention provides a computer network-based affinity program that is easier for consumers, merchants, and non-profit organizations to use. Advantageously, the program tracks and measures consumer spending, and assists merchants in creating dynamically tailored marketing programs. Furthermore, the affinity program generates lift for the merchants, which increases the merchant's profits and encourages them to participate in the program.

It is to be understood that this invention is not limited to the specific devices, methods, conditions, and/or parameters described and/or shown herein, and that the terminology used herein is for the purpose of describing particular embodiments by way of example only. Thus, the terminology is intended to be broadly construed and is not intended to be unnecessarily limiting of the claimed invention. In addition, as used in the specification including the appended claims, the singular forms “a,” “an,” and “the” include the plural, plural forms include the singular, and reference to a particular numerical value includes at least that particular value, unless the context clearly dictates otherwise. Furthermore, any methods described herein are not intended to be limited to the sequence of steps described but can be carried out in other sequences, unless expressly stated otherwise herein.

Accordingly, while certain embodiments are described above with particularity, these should not be construed as limitations on the scope of the invention. It should be understood, therefore, that the foregoing relates only to exemplary embodiments of the present invention, and that numerous changes may be made therein without departing from the spirit and scope of the invention as defined by the following claims.

What is claimed is:

1. A computer network-implemented method for use by participants, merchants, and beneficiaries to generate benefits for the beneficiaries, comprising:
a) receiving identified spending amount information by the participants at the merchants;
b) receiving actual spending amount information by the participants at the merchants; and
c) determining the beneficiary benefits payable by the merchants using a benefit determination method based on the identified spending amount information and the actual spending amount information.

2. The method of claim 1, wherein the benefit determination method includes reconciling the identified spending amount information by each of the participants at each of the merchants with the later actual spending amount information by each of the participants at each of the merchants.

3. The method of claim 1, wherein the benefit determination method includes an accurate identified spending reward plan that encourages accurately estimating the identified spending amounts.

4. The method of claim 3, wherein the accurate identified spending reward plan is based on the effective actual spending amount to generate lift for the merchant, wherein the effective actual spending amount is the lesser of the actual spending amount and the identified spending amount.

5. The method of claim 3, wherein the accurate identified spending reward plan includes a funding method for a transfer of funds in advance of the actual spending and based on the identified spending amount information.

6. The method of claim 5, wherein the accurate identified spending reward plan further includes permitting adjusting the advance transferred funds between account purses.

7. The method of claim 5, wherein the beneficiary benefit is defined as a beneficiary rebate and the benefit determination method determines the beneficiary rebate according to the equation:
BR=EAS*(NRP−ARP)
wherein:
BR=Beneficiary Rebate,
EAS=Effective Actual Spending,
NRP=Negotiated Rebate Percentage, and
ARP=Administrative Rebate Percentage.

8. The method of claim 3, wherein the accurate identified spending reward plan includes reducing the beneficiary benefit by a multiplier that represents under-spending by the participant at the merchant.

9. The method of claim 8, wherein the multiplier is the effective actual spending amount divided by the identified spending amount, wherein the effective actual spending amount is the lesser of the actual spending amount and the identified spending amount.

10. The method of claim 8, wherein the beneficiary benefit is defined as a beneficiary rebate and the benefit determination method determines the beneficiary rebate according to the equation:
BR=(EAS)*(NRP−ARP)*(EAS/IS)
wherein:
BR=Beneficiary Rebate,
EAS=Effective Actual Spending,
NRP=Negotiated Rebate Percentage,
ARP=Administrative Rebate Percentage, and
IS=Identified Spending.

11. The method of claim 3, wherein the benefit determination method determines a benefit to an administrator of the method, wherein the administrator benefit is not reduced when the actual spending is different from the identified spending.

12. The method of claim 1, further comprising receiving from the merchants instructions for offering to the participants special promotions with special promotion benefits payable to the beneficiaries.

13. A server computer or bank of server computers connected to a computer network and storing computer-executable instructions for performing the method of claim 1.

14. A computer-readable storage medium storing computer-executable instructions for performing the method of claim 1.

15. A computer network-implemented method for use by participants, merchants, and beneficiaries to generate benefits for the beneficiaries, comprising:
a) receiving identified spending amount information by the participants at the merchants;
b) receiving actual spending amount information by the participants at the merchants;
c) reconciling the identified spending amount information by each of the participants at each of the merchants with the later actual spending amount information by each of the participants at each of the merchants; and
d) determining the beneficiary benefits and the administrator benefits payable by the merchants using a benefit determination method that includes an accurate identified spending reward plan that encourages accurately estimating the identified spending amounts, wherein the accurate identified spending reward plan is based on the identified spending amount and the effective actual spending amount to generate lift for the merchant, wherein the effective actual spending amount is the lesser of the actual spending amount and the identified spending amount, and wherein the administrator benefit is not reduced when the actual spending is different from the identified spending.

16. The method of claim 15, wherein the accurate identified spending reward plan includes a funding method for transferring funds in advance of the actual spending and based on the identified spending amount information.

17. The method of claim 16, wherein the accurate identified spending reward plan further includes permitting adjusting the advance transferred funds between account purses, wherein the account purses include merchant-specific purses and a general purse.

18. The method of claim 16, wherein the beneficiary benefit is defined as a beneficiary rebate and the benefit determination method determines the beneficiary rebate according to the equation:
BR=EAS*(NRP−ARP)
wherein:
BR=Beneficiary Rebate,
EAS=Effective Actual Spending,
NRP=Negotiated Rebate Percentage, and
ARP=Administrative Rebate Percentage.

19. The method of claim 15, wherein the accurate identified spending reward plan includes reducing the beneficiary benefit by a multiplier that represents under-spending by the participant at the merchant.

20. The method of claim 19, wherein the beneficiary benefit is defined as a beneficiary rebate and the benefit determination method determines the beneficiary rebate according to the equation:
BR=(EAS)*(NRP−ARP)*(EAS/IS)
wherein:
BR=Beneficiary Rebate,
EAS=Effective Actual Spending,
NRP=Negotiated Rebate Percentage,
ARP=Administrative Rebate Percentage, and
IS=Identified Spending.

21. The method of claim 15, further comprising receiving from the merchants instructions for offering to the participants special promotions with special promotion benefits payable to the beneficiaries.

22. The method of claim 15, further comprising receiving from the beneficiaries designations of sub-groups for receiving portions of the beneficiary benefits.

23. The method of claim 15, further comprising receiving from the participants standing orders for identified spending at designated times on a regular basis.

24. The method of claim 15, further comprising providing a menu of the merchants with which a particular one of the participants has conducted actual spending transactions, and receiving from the particular participant a designation for one of the merchants on the menu for additional identified spending.

25. The method of claim 15, wherein the identified spending information is received from participant interface devices and the actual spending information is received from merchant point-of-sale devices.

26. A server computer or bank of server computers connected to a computer network and storing computer-executable instructions for performing the method of claim 15.

27. A computer-readable storage medium storing computer-executable instructions for performing the method of claim 15.

28. A benefit determination method for use in a computer network-implemented program for use by participants, benefactors, and beneficiaries to generate benefits for the beneficiaries, comprising:
a) reconciling identified spending amount information by each of the participants at each of the benefactors with later actual spending amount information by each of the participants at each of the benefactors;
b) determining the beneficiary benefits payable by the benefactors based on the identified spending amount information and effective actual spending amount information to generate lift for the benefactors, wherein the effective actual spending amount is the lesser of the actual spending amount and the identified spending amount, and further including an accurate identified spending reward plan that encourages accurately estimating the identified spending amount; and
c) determining a benefit to an administrator of the program, wherein the administrator benefit is not reduced when the actual spending is different from the identified spending.

29. The method of claim 28, wherein the accurate identified spending reward plan includes a funding method for a transfer of funds in advance of the actual spending and based on the identified spending amount information, and further includes permitting adjusting the advance transferred funds between account purses.

30. The method of claim 29, wherein the beneficiary benefit is defined as a beneficiary rebate and the benefit determination method determines the beneficiary rebate according to the equation:
BR=EAS*(NRP−ARP)
wherein:
BR=Beneficiary Rebate,
EAS=Effective Actual Spending,
NRP=Negotiated Rebate Percentage, and
ARP=Administrative Rebate Percentage.

31. The method of claim 28, wherein the accurate identified spending reward plan includes reducing the beneficiary benefit by a multiplier that represents under-spending by the participant at the merchant.

32. The method of claim 31, wherein the beneficiary benefit is defined as a beneficiary rebate and the benefit determination method determines the beneficiary rebate according to the equation:
BR=(EAS)*(NRP−ARP)*(EAS/IS)
wherein:
BR=Beneficiary Rebate,
EAS=Effective Actual Spending,
NRP=Negotiated Rebate Percentage,
ARP=Administrative Rebate Percentage, and
IS=Identified Spending.

33. A computer-readable storage medium storing computer-executable instructions for performing the method of claim 28.
